(19) United States
(12) Patent Application Publication
(10) Pub. No.: US 2026/0147379 A1
(43) Pub. Date: May 28, 2026

(54) WEARABLE DEVICE

(71) Applicant: Listen Wearables, LLC, Wilmington, DE (US)

(72) Inventors: Bruce HOCH, Durango, CO (US); Charles HOCH, Durango, CO (US); Edward KILDUFF, Kula, HI (US); Andrew David REEVES, Laguna Niguel, CA (US); Sung TRUONG, Newport Beach, CA (US); Shane Grant BLOMBERG, Wharton, NJ (US)

(21) Appl. No.: 18/959,257

(22) Filed: Nov. 25, 2024

(51) Int. Cl. G06F 1/16; G09G 3/06; G10L 13/02

(52) U.S. Cl. CPC G06F 1/163; G09G 3/06; G10L 13/02

(57) ABSTRACT

A wearable device includes a processor in electrical communication with a non-transitory computer-readable storage medium storing a plurality of messages, an actuator, an audio transducer, and a light emitter. Responsive to the actuator receiving a user input, the processor retrieves a message of the plurality of messages from the storage medium, illuminates the light emitter with a color corresponding to a theme associated with the retrieved message, and plays the message via the audio transducer.

### BACKGROUND

Wearable devices are electronic devices that can be worn on the body, such as smartwatches, fitness trackers, and augmented reality glasses, etc. While such devices as fitness trackers may provide messaging based on a user's movement or lack thereof, wearable devices do not provide stories, trivia fact-based messaging or inspirational messaging organized into one or more themes.

### BRIEF SUMMARY

In one embodiment, a wearable device includes: a processor in electrical communication with: a non-transitory computer-readable storage medium storing a plurality of messages, an actuator, an audio transducer, and a light emitter, wherein, responsive to the actuator receiving a user input, the processor: retrieves a message of the plurality of messages from the storage medium, illuminates the light emitter with a color corresponding to a theme associated with the retrieved message, and plays the message via the audio transducer.

Optionally, in some embodiments, responsive to the actuator receiving the user input, the processor: retrieves a message of the plurality of messages from the storage medium, subsequent to retrieving the message, illuminates the light emitter with a color corresponding to a theme associated with the retrieved message, and subsequent to illuminating the light emitter, plays the message via the audio transducer.

Optionally, in some embodiments, responsive to the actuator receiving the user input, the processor: selects a theme from the plurality of themes; retrieves a message of the plurality of messages from the storage medium based on the theme, subsequent to retrieving the message, illuminates the light emitter with a color corresponding to a theme associated with the retrieved message, and subsequent to illuminating the light emitter, plays the message via the audio transducer.

Optionally, in some embodiments, at least one theme of the plurality of themes describes an emotion.

Optionally, in some embodiments, at least one theme of the plurality of themes describes a fact type.

Optionally, in some embodiments, the emotion includes one or more of joy, forgiveness, contentment, reverence, calm or empowerment.

Optionally, in some embodiments, the messages of the plurality of messages include words.

Optionally, in some embodiments, the messages of the plurality of messages include a recorded human voice.

Optionally, in some embodiments, the messages of the plurality of messages include a simulated human voice.

Optionally, in some embodiments, the processor selects the retrieved message randomly.

Optionally, in some embodiments, the processor selects the retrieved message randomly based on a selected theme of the plurality of themes.

Optionally, in some embodiments, at least one of the plurality of messages can be uploaded to the device by a user.

Optionally, in some embodiments, two or more of the plurality of messages are played in a selected sequence.

Optionally, in some embodiments, the sequence includes a parable.

Optionally, in some embodiments, the processor selects the retrieved message based on a user feedback.

Optionally, in some embodiments, the feedback includes one or more of a manual input or a biofeedback.

Optionally, in some embodiments, the processor is in wireless communication with a personal device.

Optionally, in some embodiments, the personal device is configured to receive the user input, selecting a message of the plurality of messages for later playback.

Optionally, in some embodiments, the processor is in wireless communication with a second processor of a second wearable device.

Optionally, in some embodiments, the one of the processor or the second processor is configured to transmit the retrieved message to the other of the second processor or the processor via the wireless communication.

Optionally, in some embodiments, the light emitter illuminates the actuator.

Optionally, in some embodiments, the plurality of messages includes excerpts from a scripture.

Optionally, in some embodiments, the device includes a modular wearable device connectable to a plurality of carrier structures.

Optionally, in some embodiments, the plurality of carrier structures is one or more of a wrist band, a pendant, a necklace, a brooch, a tie pin, a cuff link, an earring, or a ring.

Optionally, in some embodiments, the scripture includes one or more of The New Testament, The Old Testament, The Quran, The Tanakh, The Torah, The Nevi'im, The Ketuvim, The Vedas, The Upanishads, The Bhagavad Gita, The Ramayana, The Mahabharata, The Tripitaka, The Mahayana Sutras, The Tibetan Book of the Dead, The Guru Granth Sahib, The Book of Mormon, The Doctrine and Covenants, The Pearl of Great Price, The Kitab-i-Aqdas, The Writings of Baha'u'llah, The Avesta, The Yasna, The Visperad, or The Vendidad.

In one embodiment, a non-transitory computer-readable storage medium, the computer-readable storage medium including instructions that when executed by a computer, cause the computer to: retrieve a message of a plurality of messages stored in the storage medium, wherein each message is categorized into at least one of a plurality of themes; illuminate a light emitter with a color corresponding to a theme associated with the retrieved message, and plays the message via an audio transducer.

Optionally, in some embodiments, at least one theme of the plurality of themes describes an emotion.

Optionally, in some embodiments, at least one theme of the plurality of themes describes a fact type.

Optionally, in some embodiments, the emotion includes one or more of joy, forgiveness, contentment, reverence, calm or empowerment.

Optionally, in some embodiments, the messages of the plurality of messages include words.

Optionally, in some embodiments, the messages of the plurality of messages include a recorded human voice.

Optionally, in some embodiments, the messages of the plurality of messages include a simulated human voice.

Optionally, in some embodiments, the processor selects the retrieved message randomly.

Optionally, in some embodiments, the processor selects the retrieved message randomly based on a selected theme of the plurality of themes.

Optionally, in some embodiments, at least one of the plurality of messages can be uploaded to the device by a user.

Optionally, in some embodiments, two or more of the plurality of messages are played in a selected sequence.

Optionally, in some embodiments, the sequence includes a parable.

Optionally, in some embodiments, the processor selects the retrieved message based on a user feedback.

Optionally, in some embodiments, the feedback includes one or more of a manual input or a biofeedback.

Optionally, in some embodiments, the processor is in wireless communication with a personal device.

Optionally, in some embodiments, the personal device is configured to receive a user input, selecting a message of the plurality of messages for later playback.

Optionally, in some embodiments, the processor is in wireless communication with a second processor of a second wearable device.

Optionally, in some embodiments, the one of the processor or the second processor is configured to transmit the retrieved message to the other of the second processor or the processor via the wireless communication.

Optionally, in some embodiments, the light emitter illuminates the actuator.

Optionally, in some embodiments, the plurality of messages include excerpts from a scripture.

Optionally, in some embodiments, the device includes a modular wearable device connectable to a plurality of carrier structures.

Optionally, in some embodiments, the plurality of carrier structures is one or more of a wrist band, a pendant, a necklace, a brooch, a tie pin, a cuff link, an earring, or a ring.

Optionally, in some embodiments, the scripture includes one or more of The New Testament, The Old Testament, The Quran, The Tanakh, The Torah, The Nevi'im, The Ketuvim, The Vedas, The Upanishads, The Bhagavad Gita, The Ramayana, The Mahabharata, The Tripitaka, The Mahayana Sutras, The Tibetan Book of the Dead, The Guru Granth Sahib, The Book of Mormon, The Doctrine and Covenants, The Pearl of Great Price, The Kitab-i-Aqdas, The Writings of Baha'u'llah, The Avesta, The Yasna, The Visperad, or The Vendidad.

In some embodiments, a system includes: a first wearable device; and a second wearable device, wherein: the first wearable device and the second wearable device are in wireless communication with one another, each of the first wearable device and the second wearable device includes: a processor in electrical communication with a non-transitory computer-readable storage medium storing a plurality of messages, each message being categorized into at least one of a plurality of themes, and one of the first wearable device or the second wearable device is configured to transit a message of the plurality of messages to the other of the second wearable device or the first wearable device via the wireless communication.

Optionally, in some embodiments, each of the first wearable device and the second wearable device includes: an actuator; an audio transducer; and a light emitter, wherein responsive to the actuator receiving a user input, the processor or the respective user device receiving the user input plays the transmitted message via the audio transducer, and illuminates the light emitter with a color corresponding to a theme associated with the transmitted message.

### BRIEF DESCRIPTION OF THE DRAWINGS

FIG. 1A is a right perspective view of an embodiment of a wearable device.

FIG. 1B is a left perspective view of the wearable device of FIG. 1A in a first configuration.

FIG. 1C is a left perspective view of the wearable device of FIG. 1A in a second configuration.

FIG. 1D is a left elevation view of the wearable device of FIG. 1A being coupled to an embodiment of a carrier structure.

FIG. 1E is a left perspective view of the wearable device of FIG. 1A being coupled to the carrier structure of FIG. 1D.

FIG. 1F is a left elevation view of the wearable device of FIG. 1A coupled to the carrier structure of FIG. 1D.

FIG. 1G is a left perspective view of the wearable device of FIG. 1A coupled to the carrier structure of FIG. 1D.

FIG. 2 is a right perspective view of an embodiment of a wearable device.

FIG. 3A is a right, front perspective view of an embodiment of a wearable device coupled to an embodiment of a carrier structure.

FIG. 3B is a partially exploded right rear perspective view of the wearable device of FIG. 3A and an embodiment of a carrier structure of FIG. 3A.

FIG. 3C is a right rear perspective view of the wearable device of FIG. 3A coupled with the carrier structure of FIG. 3A.

FIG. 3D is a partially exploded top right perspective view of the wearable device of FIG. 3A being and an embodiment of a carrier structure.

FIG. 3E is a top right perspective view of the wearable device of FIG. 3A coupled to the carrier structure of FIG. 3D.

FIG. 3F is a bottom right perspective view of the wearable device of FIG. 3A coupled to the carrier structure of FIG. 3D.

FIG. 3G is a partially exploded right perspective view of the wearable device of FIG. 3A and an embodiment of a carrier structure.

FIG. 3H is a right perspective view of the wearable device of FIG. 3A coupled to the carrier structure of FIG. 3A.

FIG. 4A is a top right perspective view of an embodiment of a wearable device.

FIG. 4B is a top left perspective view of the wearable device of FIG. 4A.

FIG. 4C is a bottom right perspective view of the wearable device of FIG. 4B.

FIG. 5 is a top right perspective view of an embodiment of a wearable device.

FIG. 6A is a partially exploded top right perspective view of an embodiment of a wearable device and an embodiment of a carrier structure.

FIG. 6B is a right elevation view of the wearable device of FIG. 6B being coupled to the carrier structure of FIG. 6A.

FIG. 6C is a top right perspective view of the wearable device of FIG. 6A coupled to the carrier structure of FIG. 6A.

FIG. 6D is a right perspective view of the wearable device of FIG. 6A coupled to an embodiment of a carrier structure.

FIG. 6E is a top perspective view of the wearable device of FIG. 6A coupled to an embodiment of a carrier structure.

FIG. 6F is a right perspective view of the wearable device of FIG. 6A coupled to an embodiment of a carrier structure.

FIG. 7 is a right perspective view of an embodiment of a wearable device.

FIG. 8-FIG. 13 are examples of methods of configuring or operating any wearable device disclosed herein.

FIG. 14 is a schematic view of a system of wireless communication between two or more wearable devices.

FIG. 15 is an embodiment of a method of operating the system of FIG. 14.

FIG. 16 is a schematic view of a system of wireless communication between two or more wearable devices and a user device.

FIG. 17 is an embodiment of a method of operating the system of FIG. 16.

FIG. 18 is a simplified block diagram of components of any wearable device disclosed herein.

### DETAILED DESCRIPTION

Wearable devices disclosed herein include an actuator, a light emitter, and an audio transducer. Responsive to a user pressing or otherwise providing an input to the actuator, the wearable devices play one or more audio messages retrieved from a memory device (typically within the wearable device) via the audio transducer.

The audio messages may be categorized into one or more themes. In some embodiments, a theme may represent an emotion. In some embodiments, a theme may represent a type of fact, e.g., when a wearable device is operating in fact mode. In some embodiments, the wearable devices disclosed may operate in “story mode” where the device plays one or more portions or pages of a story or parable.

Based on the theme of a selected message, the wearable device may illuminate the light emitter with a color corresponding to the theme of the message. For example, where a message is categorized with a theme of “joy,” the light emitter may light green, indicating the selected message is joyful. The wearable device plays the message via the audio transducer as the light emitter illuminates with a color corresponding to the theme of the message being played. In some embodiments, the wearable device selects a theme and then selects messages having been categorized with that theme. In such embodiments, the playback of the message and/or the illumination of the light emitter is as described above. In various embodiments, the message may be played before the light emitter illuminates, after the light emitter illuminates, or substantially at the same time as the light emitter illuminates. The playback of the message may be one or more of a recorded human voice, or a synthesized or simulated voice (human or otherwise).

In many embodiments, the messages are selected excerpts from an inspirational text such as a scripture. For example, the messages may be selected from one or more of: The New Testament, The Old Testament, The Quran, The Tanakh, The Torah, The Nevi'im, The Ketuvim, The Vedas, The Upanishads, The Bhagavad Gita, The Ramayana, The Mahabharata, The Tripitaka, The Mahayana Sutras, The Tibetan Book of the Dead, The Guru Granth Sahib, The Book of Mormon, The Doctrine and Covenants, The Pearl of Great Price, The Kitab-i-Aqdas, The Writings of Baha'u'llah, The Avesta, The Yasna, The Visperad, or The Vendidad. In some embodiments, the messages may be selected from a collection of facts, e.g., facts about the moon.

The wearable devices may be modular devices that are coupled or coupleable to one or more carrier structures, such as a wrist band, a pendant, a necklace, a brooch, a tie pin, a cuff link, an earring, or a ring, etc.

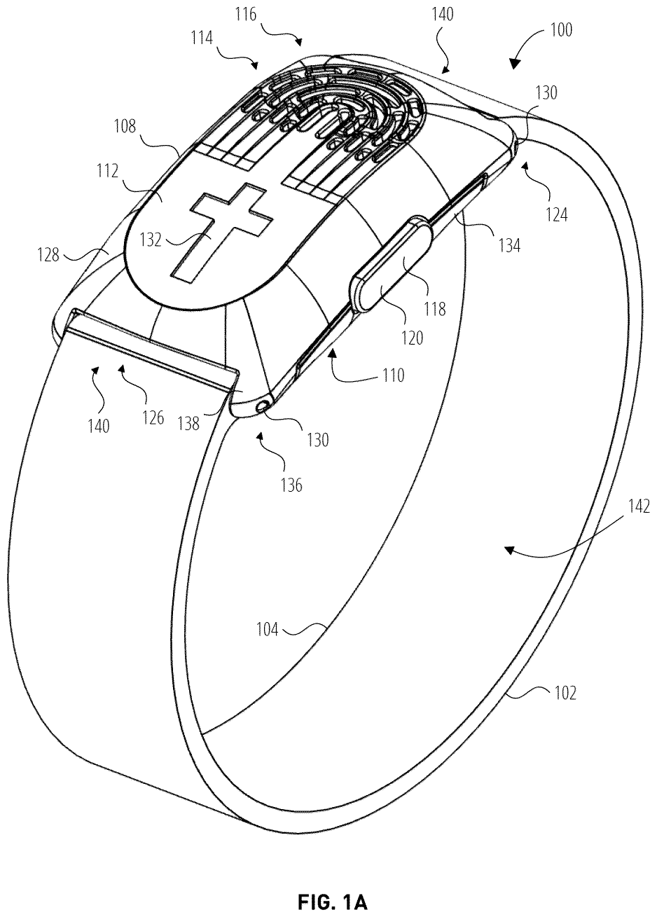

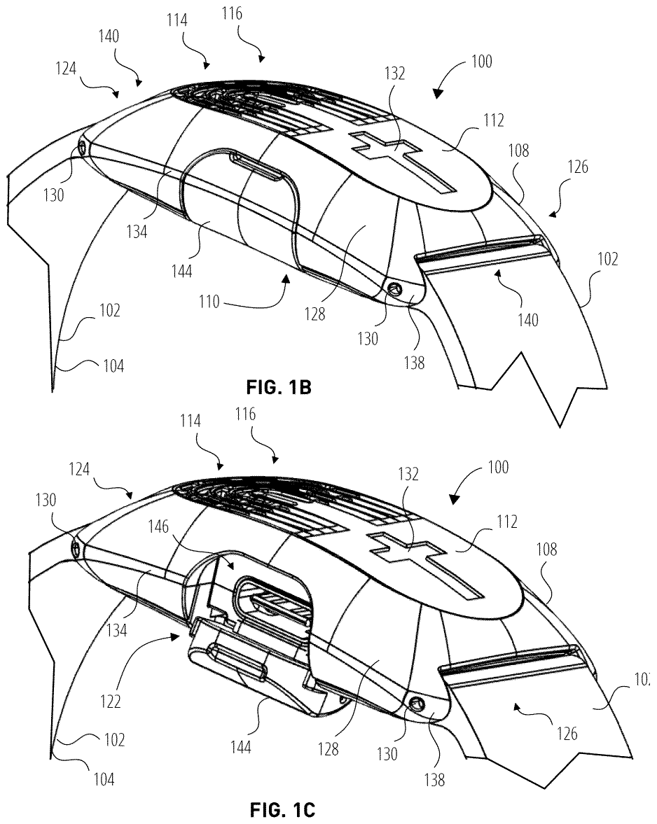

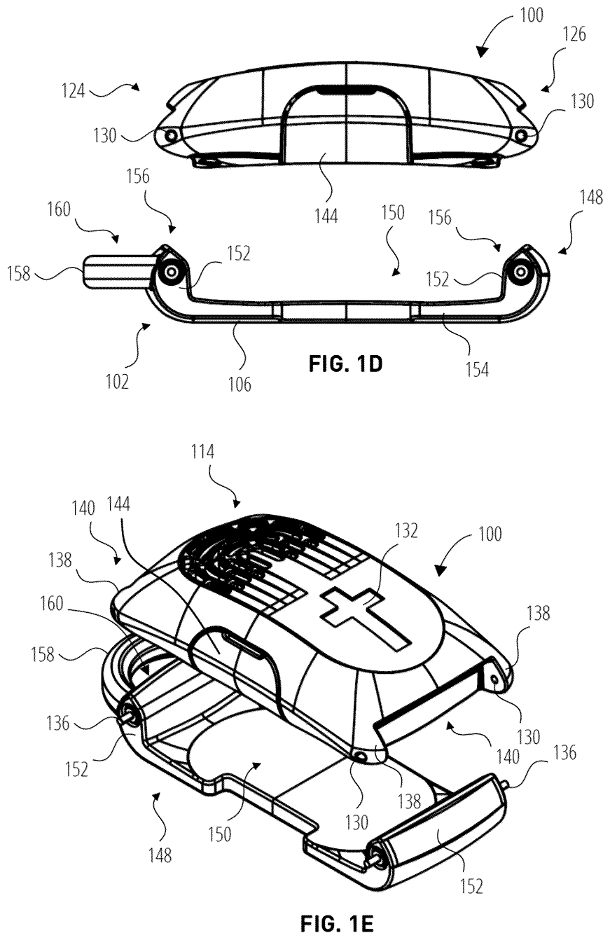

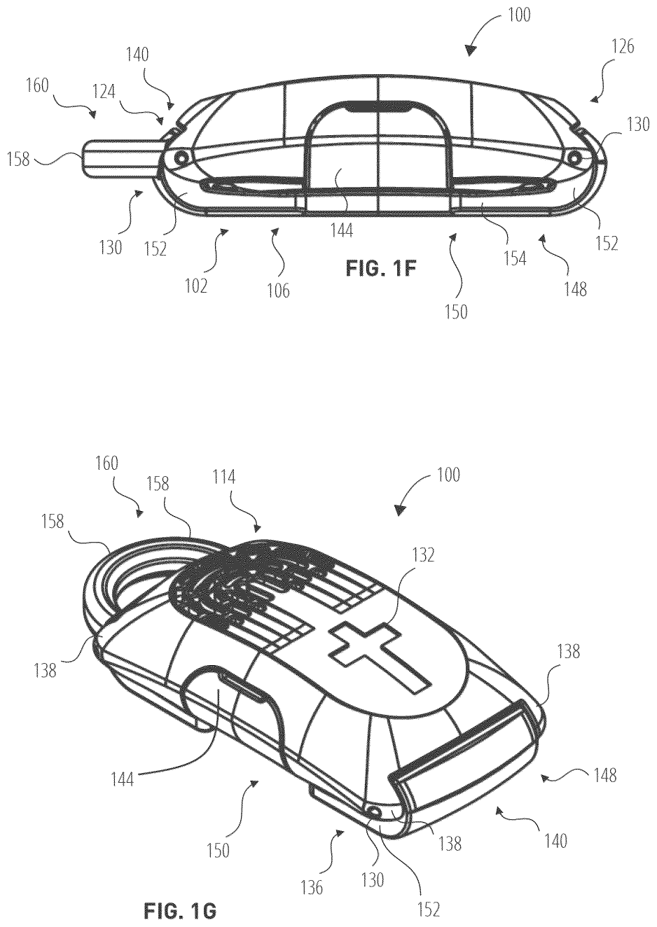

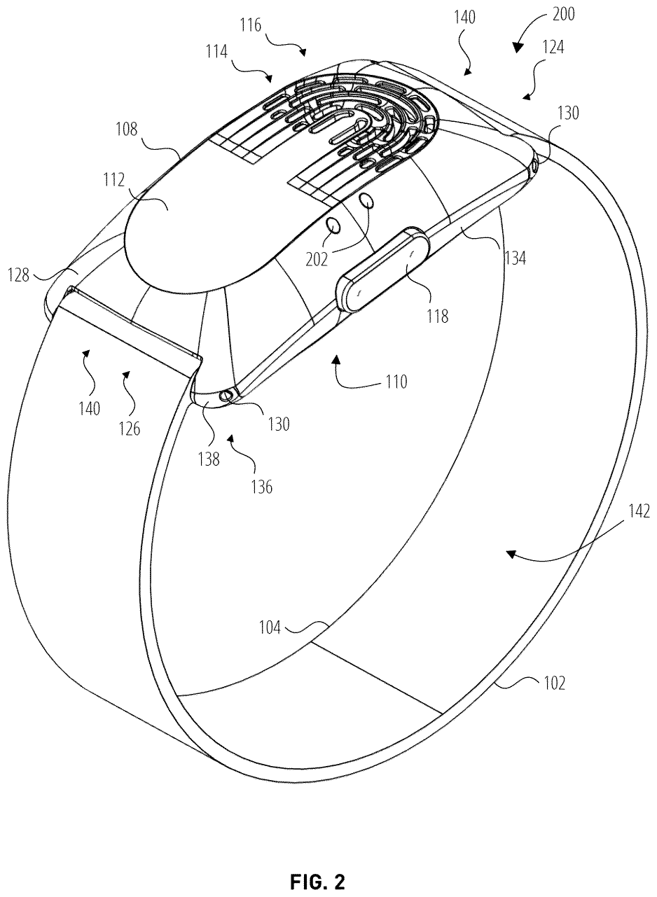

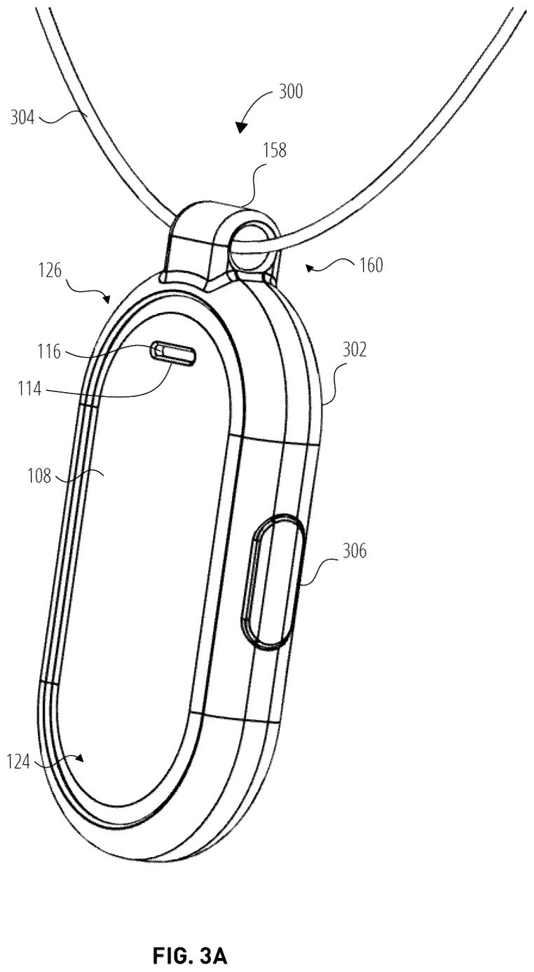

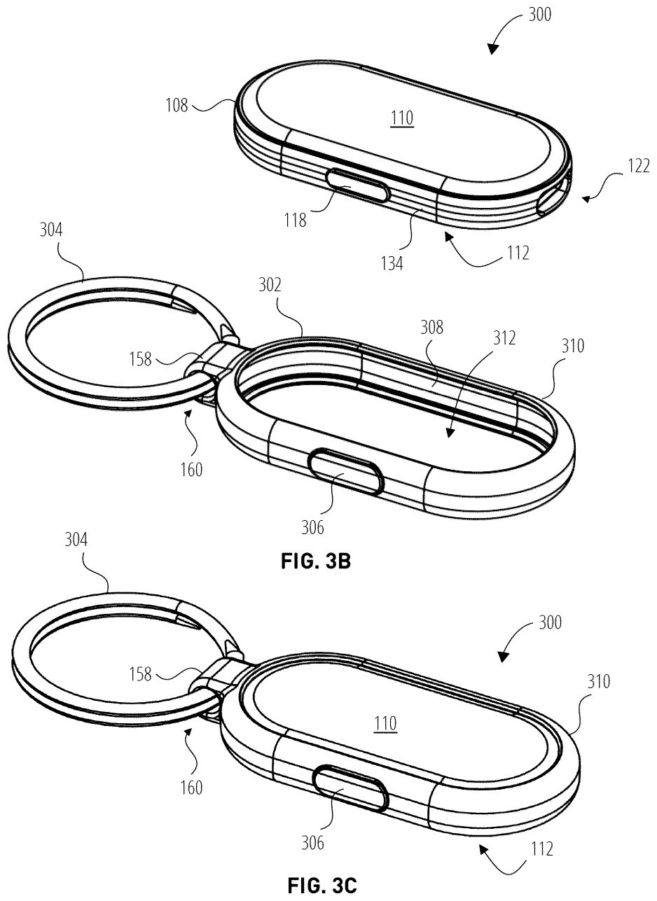

Turning to the figures, FIG. 1A-FIG. 1G show an embodiment of a wearable device 100.

The wearable device 100 includes a main body 108. The main body 108 includes a rear panel 110 and an opposite front panel 112. The rear panel 110 and front panel 112 may meet at respective opposite end portions 124/126. The rear panel 110 and the front panel 112 may also meet at an edge panel 134. In some embodiments, a transition portion 128 is provided between one or more respective panels, such as between the front panel 112 and the edge panel 134, or between the front panel 112 and the end portion 124 or end portion 126. The transition portion 128 may provide a smooth or aesthetically pleasing shape to the main body 108.

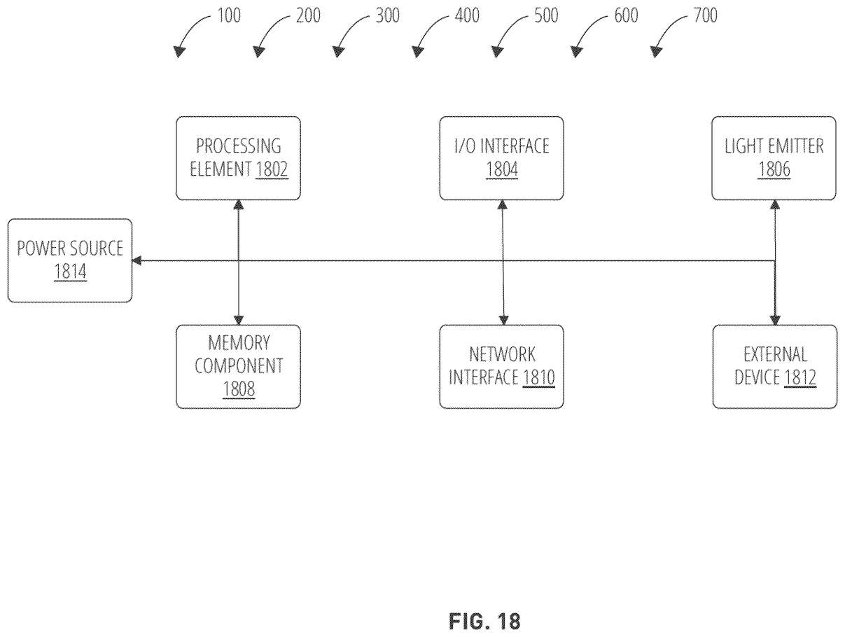

The main body 108 forms an internal compartment that houses the components of the wearable device 100, such as the processing element 1802, the I/O interface 1804, the light emitter 1806, the memory component 1808, the network interface 1810, a power supply such as a battery, etc. See, e.g., FIG. 18 and related description for more details.

A grille 114 may be formed in, or coupled to, one or more panels of the wearable device 100, typically the front panel 112. The grille 114 protects the audio transducer 116 of the wearable device 100, yet allows sound generated by the audio transducer 116 to be transmitted outside the main body 108.

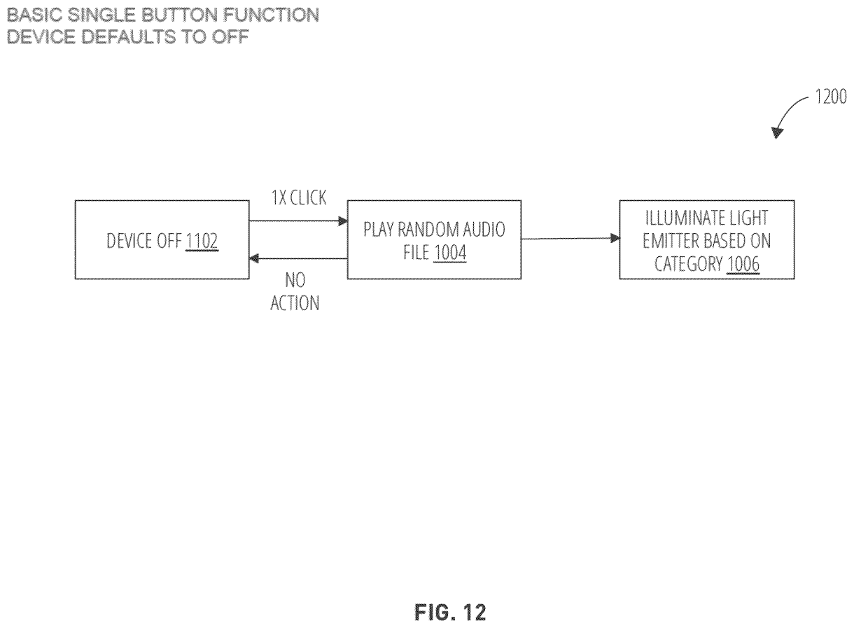

A thematic element 132 may be included in one or more panels. As shown for example in FIG. 1A, the thematic element 132 may be a religious symbol. In other embodiments, the thematic element 132 may be a character 702 (see, e.g., FIG. 7).

The wearable device 100 includes a light emitter 120. For example, the light emitter 120 may be one or more light emitting diodes (LEDs) that can illuminate with any visible light color, such as green, red, blue, purple, amber, white, etc.

The wearable device 100 includes an actuator 118 that receives a user input to cause the wearable device 100 to select and play a message as disclosed herein. In the example shown in FIG. 1A, the actuator 118 and the light emitter 120 are unitarily formed. For example, the actuator 118 may include a light pipe that receives light from an LED module within the main body 108 and transmits light generated by the light emitter 120 to the area outside the main body 108 (e.g., to a location where the generated light may be viewable by a user). In some embodiments, a wearable device may include a sensor such as a biofeedback sensor in place of, or in addition to, the actuator to control the same or similar actions as the actuator 118.

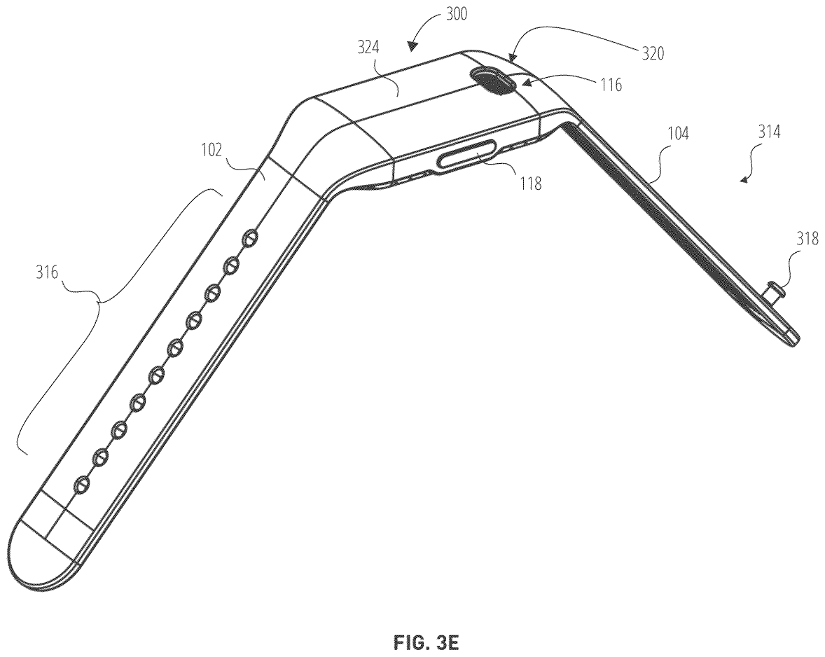

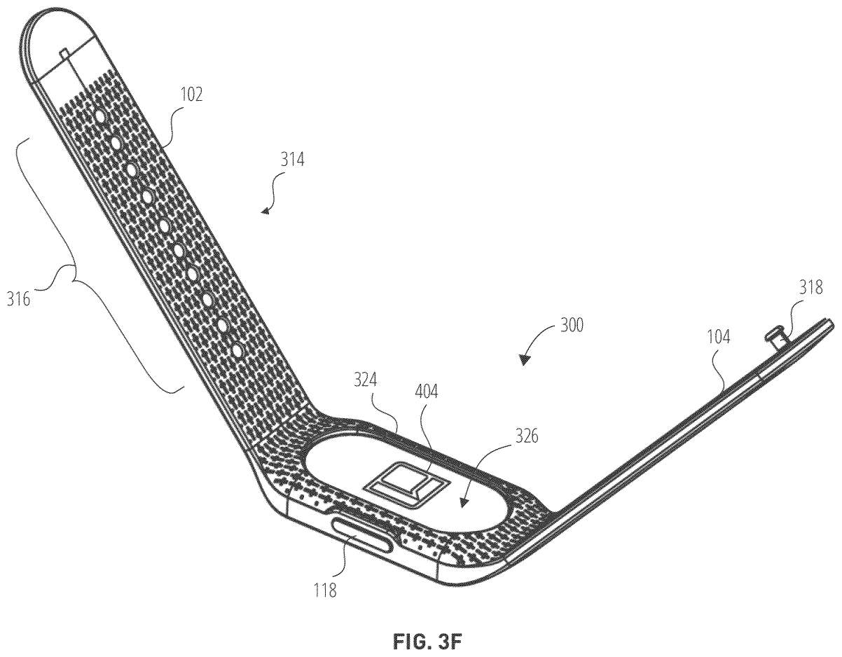

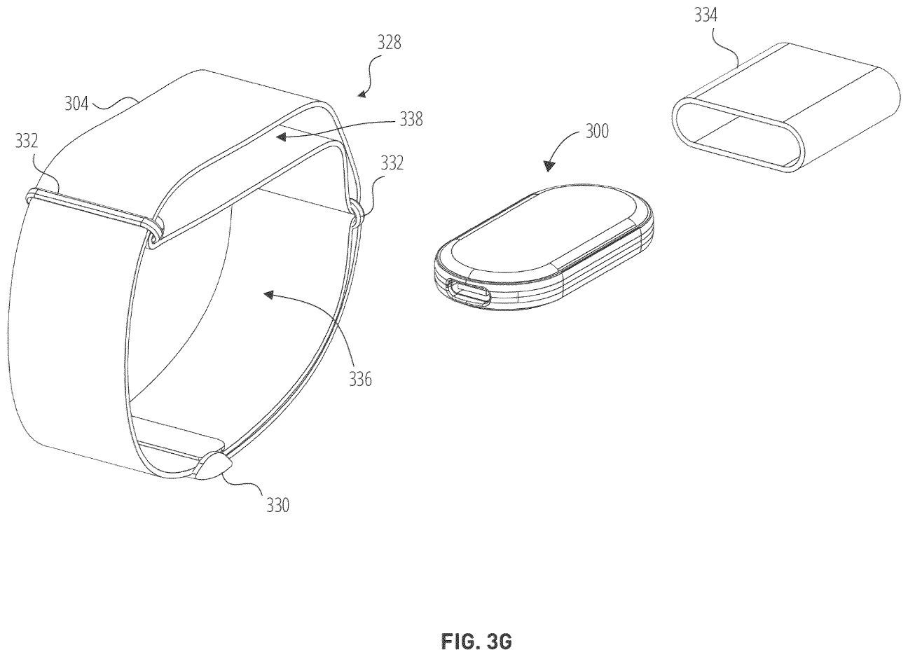

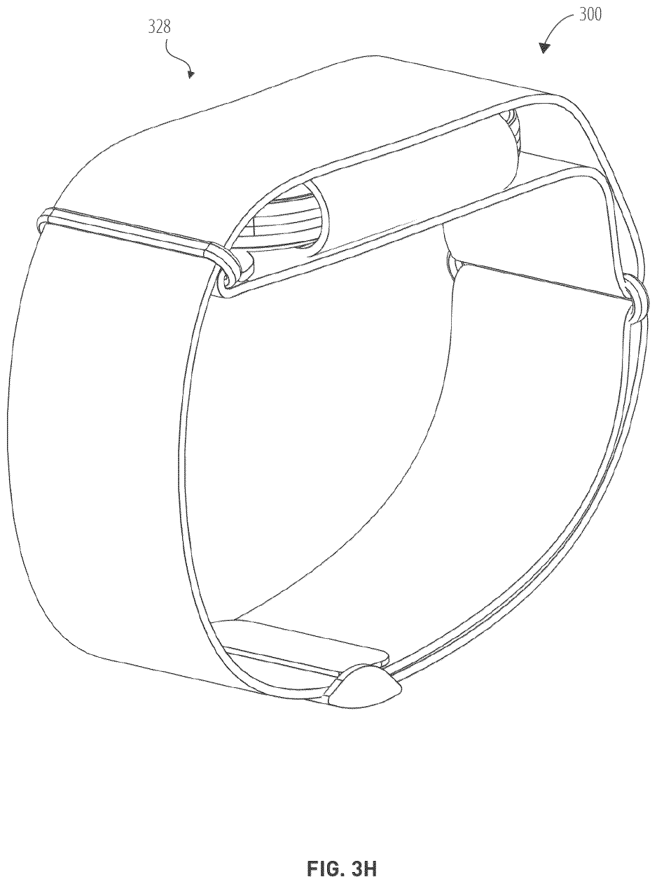

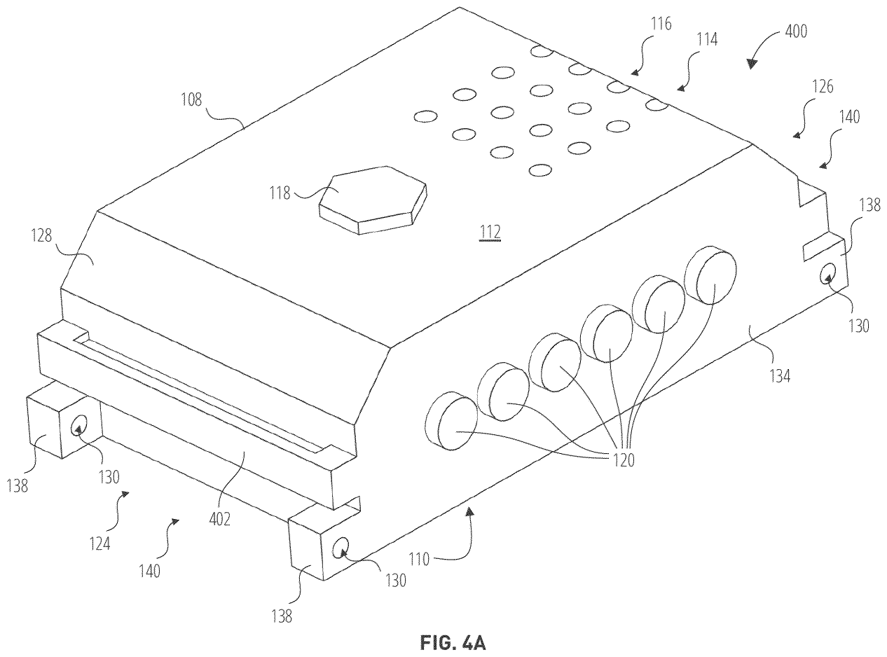

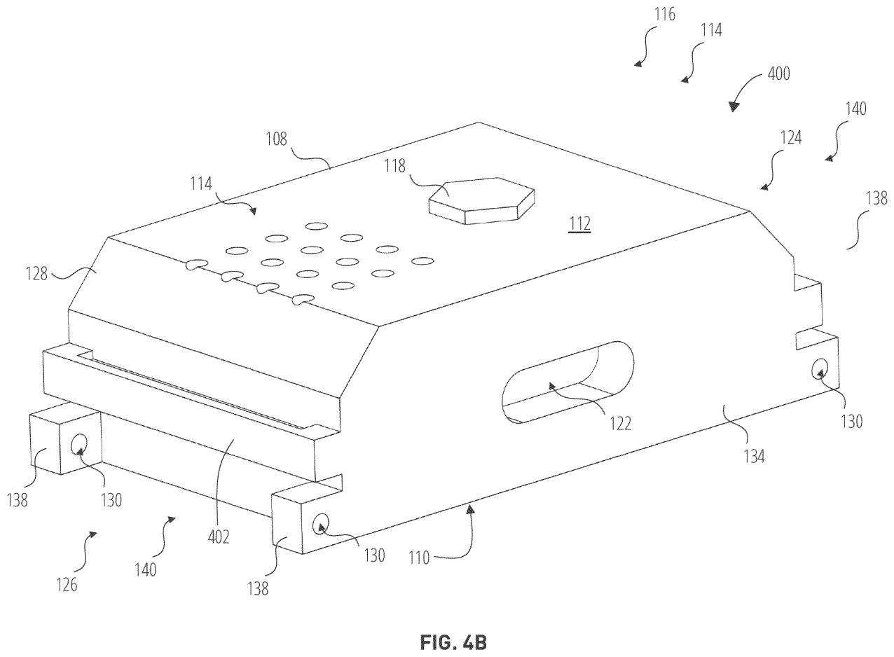

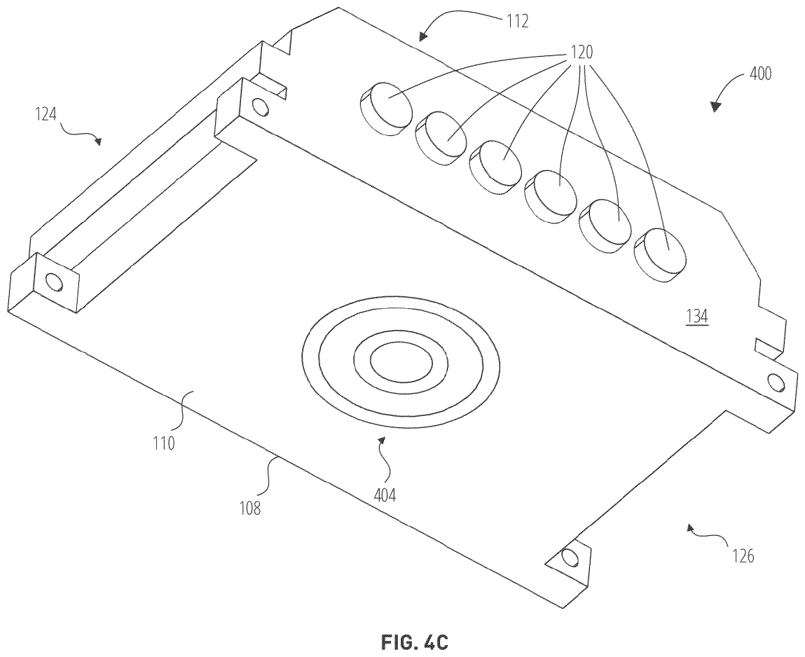

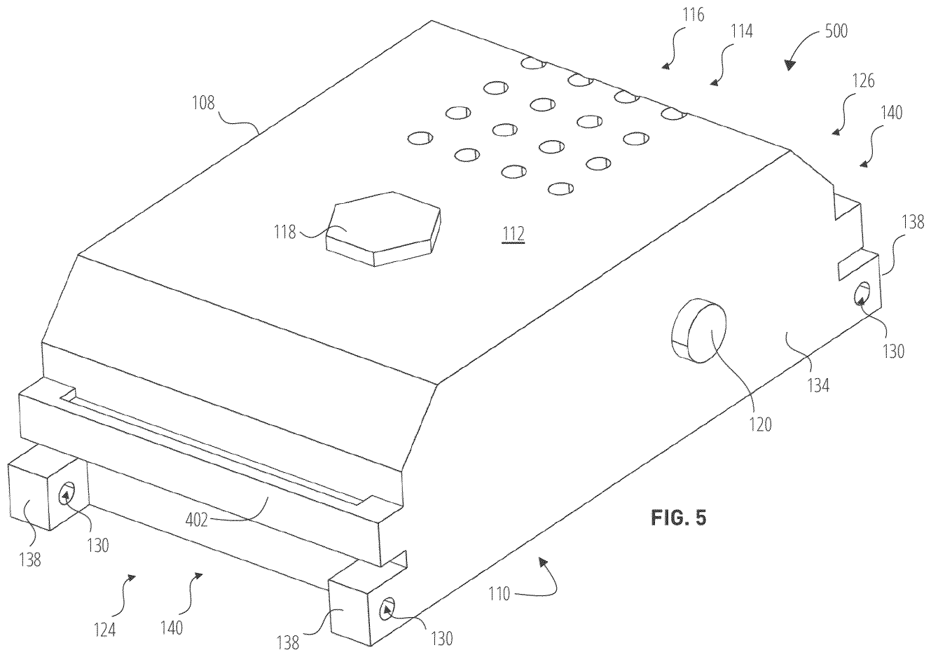

In some examples, the main body 108 may include one or more flanges 138 that form a receiver 140. In many embodiments, the receiver 140 is disposed at one or both of the end portions 124/126. The flanges 138 may have respective apertures 130 formed therethrough and adapted to receive a pin 136. The pin 136 couples the main body 108 to an optional carrier structure 102, such as an elongated element 104 like a wrist strap forming a main aperture 142 suitable to receive a user's wrist or other body part. In some embodiments, the pin 136 is a spring pin that is at least partly collapsible such that the main body 108 may be selectively coupled or uncoupled from the carrier structure 102 or to another carrier structure (see, e.g., the carrier structure 302, carrier structure 314, or carrier structure 328 described with respect to FIG. 3A-FIG. 3G).

As shown for example in FIG. 1B and FIG. 1C, the wearable device 100 may include a cover 144 that selectively seals a charging port 122. FIG. 1B shows the cover 144 in a closed configuration. FIG. 1C shows the cover in an open position, exposing the charging port 122. For example, the cover 144 may sit within a recess 146 formed in the main body 108, such that, when closed, the cover 144 is substantially flush with the main body 108. In some embodiments, the charging port 122 is a universal serial bus (USB) connector, such as a mini-USB, micro-USB, USB-C, or other similar connector. The charging port 122 may provide for charging the power source 1814. The cover 144 may be a partially or fully resilient material. The cover 144 may seal the recess 146 from ingress of contaminants, water, etc.

FIG. 1D-FIG. 1G show the wearable device 100 in the process of being coupled to or decoupled from a carrier structure 148, such as a clip 106. For example, the carrier structure 148 includes a base 154 from which one or more flanges 152 protrude. The flanges 152 are disposed at opposing ends of the base 154. The flanges 152 form a receptacle 150 therebetween. The receptacle 150 is adapted to receive the wearable device 100. The flanges 152 include respective apertures 156 formed therethrough. When the wearable device 100 is received in the receptacle 150 (e.g., FIG. 1F and FIG. 1G), the apertures 130 align with the apertures 156, such that the pins 136 can be received in the respective apertures 130 and 156 to selectively couple to the wearable device 100 to the carrier structure 148.

The carrier structure 148 may include a hoop 158 at one or both ends (e.g., adjacent to the flanges 152). The hoop 158 forms an opening 160 that may facilitate attachment of the carrier structure 148 to another device, such as a neckless, ring, key ring, etc.

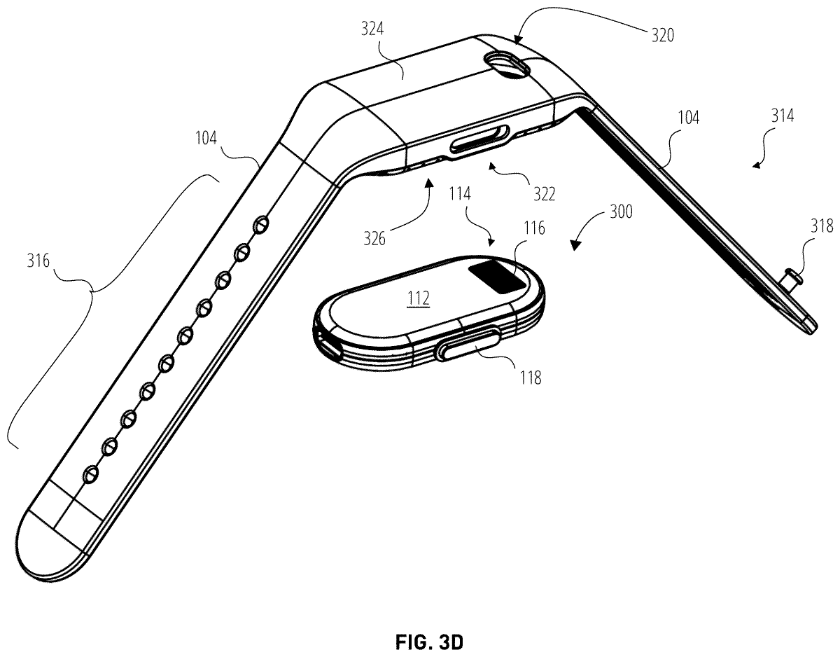

Turning to FIG. 2, a wearable device 200 is shown. The wearable device 200 is similar to the wearable device 100 in many aspects. For example, the wearable device 200 includes a main body 108, a rear panel 110, a front panel 112, a grille 114, an audio transducer 116, an actuator 118, an end portion 124, an end portion 126, a transition portion 128, an aperture 130, an edge panel 134, a pin 136, a flange 138, a receiver 140, and a main aperture 142. The wearable device 200 is coupleable to a carrier structure 102, or a carrier structure 148 similar to the wearable device 100. The wearable device 200 may optionally include a thematic element 132 (not shown in FIG. 2).

The wearable device 200 may differ from the wearable device 100 in that the wearable device 200 includes a light emitter 202 separate from the actuator 118. Like the light emitter 120, the light emitter 202 may include one or more LEDs and/or one or more light pipes. The light emitter 202 may illuminate with any visible color, based on a theme of a selected message being played on the audio transducer 116.

Turning to FIG. 3A-FIG. 3H, a wearable device 300 is shown. The wearable device 300 is similar to the wearable device 100 and the wearable device 200 in many aspects. For example, the wearable device 300 includes a main body 108 with a rear panel 110, a front panel 112 joined by an edge panel 134. An actuator 118 and a charging port 122 are disposed along the edge panel 134. A grille 114 is disposed in a panel, such as the front panel 112, and protects an audio transducer 116.

The wearable device 300 may differ from the wearable device 100 and the wearable device 200 in the placement of the charging port 122. For example, the charging port 122 may be disposed at an end portion 124 or end portion 126 of the main body 108 in an edge panel 134. The wearable device 300 may not include a cover 144. Further, the wearable device 300 may not include a transition portion 128, such that the main body 108 of the wearable device 300 is substantially planar with the front panel 112 and the rear panel 110 being substantially parallel to one another.

As shown for example in FIG. 3B and FIG. 3C, the main body 108 of the wearable device 300 may be receivable in a carrier structure 302. The carrier structure 302 includes a body 310 that forms a loop in a shape suitable to receive the wearable device 300. For example, the body 310 forms a main opening 312 suited to receive the main body 108 of the wearable device 300. The inner surface of the body 310 forms a race 308. The race 308 is shaped to couple to the edge panel 134 of the wearable device 300. The body 310 may include a hoop 158 that forms an opening 160 suitable for attaching the carrier structure 302 to another structure such as an elongated element 304, like a neckless, key ring, split ring, etc. The body 310 includes an actuator cover 306 positioned over the actuator 118 when the main body 108 is received in the main opening 312.

As shown for example in FIG. 3D-FIG. 3F, the wearable device 300 may be receivable in a carrier structure 314 such as a strap (e.g., a wrist, arm, or body strap). The carrier structure 314 includes a body 324 with a first elongated element 104 extending from a first portion thereof and a second elongated element 104 extending from an opposite, second portion thereof. For example, the elongated elements 104 may form wrist straps. Either or both of the elongated elements 104 may include a plurality of apertures 316 formed through the respective elongated element 104. Either or both of the elongated elements 104 may include a post 318 disposed thereon, or formed therewith. The post 318 is receivable in one of the plurality of apertures 316 to close the wrist strap about a user's wrist. The user may select an aperture of the plurality of apertures based on the size of their wrist, ankle, arm, etc.

The body 324 forms a receptacle 326 adapted to receive the wearable device 300 (e.g., selectively receive). The body 324 includes an audio port 320 and an actuator port 322. The audio port 320 is disposed to align with the grille 114 and the audio transducer 116 when the wearable device 300 is received in the receptacle 326. Similarly, the actuator port 322 is disposed in the body 324 such that the actuator 118 is aligned with the actuator port 322 when the wearable device 300 is received in the body 324. Thus, a user can provide a user input to the actuator 118 and the audio transducer 116 can provide sound through the grille 114 and the audio port 320 to the space outside the wearable device 300.

Turning to FIG. 3G and FIG. 3H, a carrier structure 328 is shown. The wearable device 300 is selectively receivable in the carrier structure 328. The carrier structure 328 includes an elongated element 304. The elongated element 304 forms a main loop 336 adapted to receive a portion of a user's body (e.g., wrist, arm, ankle, etc.) The elongated element 304 also forms a sub loop 338 that receives the wearable device 300. For example, the sub loop 338 includes a sleeve 334 (shown dis-assembled in FIG. 3G) that selectively receives the wearable device 300. The carrier structure 328 includes a clasp 330 and one or more rings 332 that form the main loop 336 and the sub loop 338. Rings 332 provide for adjustment of the size of the main loop 336 to fit various sizes of portions of a user's body. The clasp 330 provides for the carrier structure 328 to be easily opened and closed (such as for donning or doffing the carrier structure 328) without resizing the main loop 336.

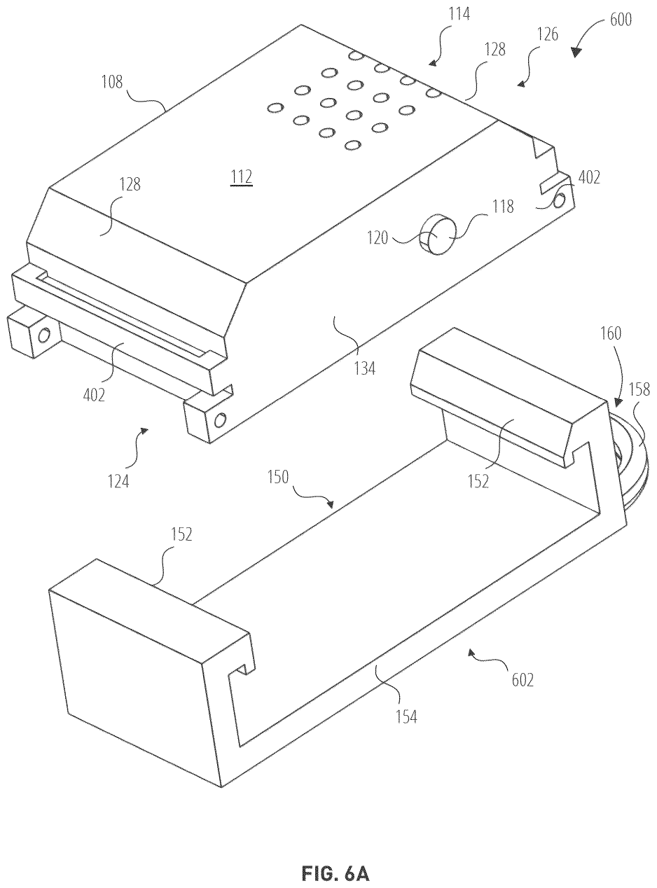

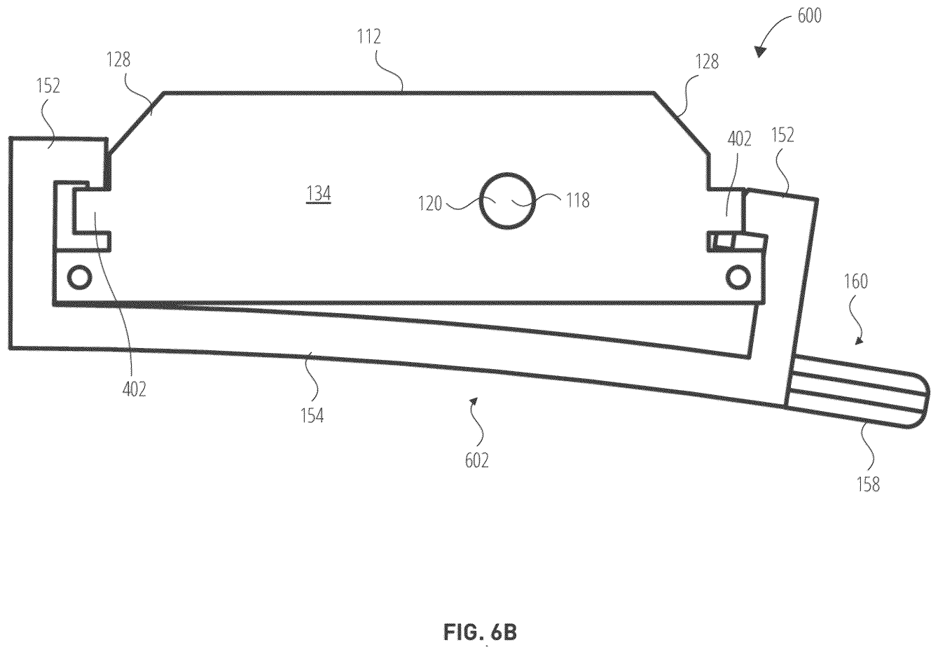

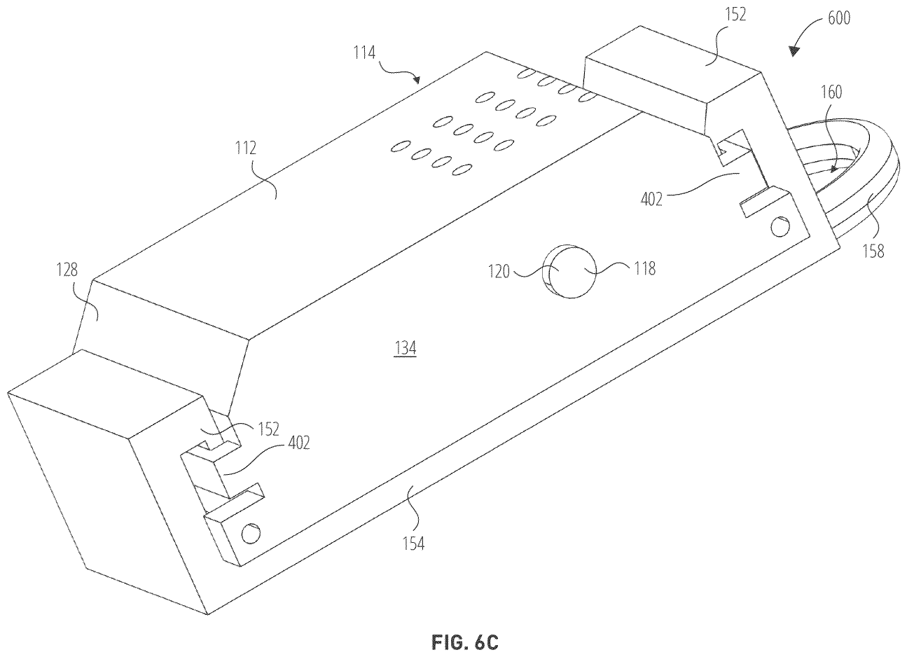

Turning to FIG. 4A-FIG. 4C, a wearable device 400 is shown. The wearable device 400 is similar to the other wearable devices disclosed herein, such as the wearable device 100, 200, and/or 300 in many aspects. For example, the wearable device 400 includes a main body 108 with a rear panel 110, and a front panel 112, joined by an edge panel 134, an end portion 124, an end portion 126 and optionally, a transition portion 128. The wearable device 400 includes a grille 114 that protects an audio transducer 116. An actuator 118 is disposed on a panel of the main body 108, such as the front panel 112. The end portions 124/126 include flanges 138 that form a receiver 140. The flanges 138 include respective apertures therethrough adapted to receive pins 136 to couple the wearable device 400 to one or more carrier structures.

The wearable device 400 may differ from the wearable device 100, the 200, and/or the 300 in that the wearable device 400 includes a plurality of light emitters 120. Rather than the multi-color light emitter 120 of the wearable device 100, 200, or 300, the light emitters 120 of the wearable device 400 may be configured to illuminate with a single color based on the theme of the selected message. Additionally, or alternately, the actuator 118 may be separate from the light emitters 120 (similar to the wearable device 200).

The wearable device 400 may also differ from the wearable device 100, 200, and/or 300 in that the end portions 124/126 include respective tangs 402 to couple the wearable device 400 to a carrier structure, in addition to, or as an alternate to, the pins 136.

As shown for example in FIG. 4B, the wearable device 400 may include a charging port 122 as described with respect to the wearable device 100. As shown for example in FIG. 4C, the wearable device 400 may optionally or additionally include a charging coil 404 disposed on a panel thereof (e.g., on a rear panel 110). The charging coil may be an inductive coil that charges the power source 1814 without a conductive wired connection to a charger (e.g., wireless charging). Any wearable device disclosed herein may include either or both of a charging port 122 and/or charging coil 404.

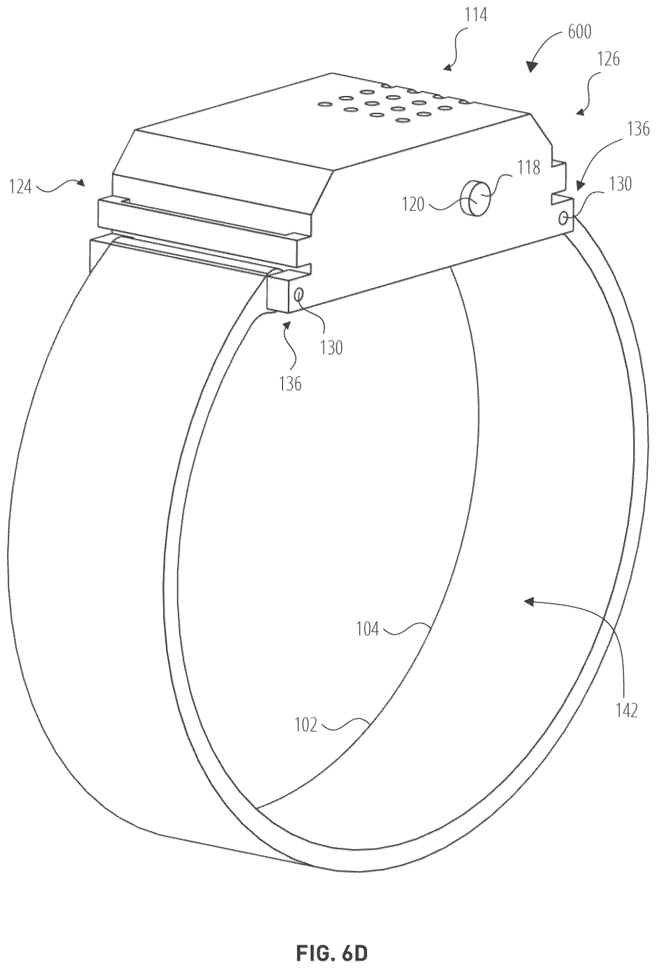

Turning to FIG. 5, a wearable device 500 is shown. The wearable device 500 is similar to the other wearable devices disclosed herein, such as the wearable device 100, 200, 300, and/or 400 in many aspects. For example, the wearable device 500 includes a main body 108 with a rear panel 110, and a front panel 112, joined by an edge panel 134, an end portion 124, an end portion 126 and optionally, a transition portion 128. The wearable device 500 includes a grille 114 that protects an audio transducer 116. An actuator 118 is disposed on a panel of the main body 108, such as the front panel 112. The end portions 124/126 include flanges 138 that form a receiver 140. The flanges 138 include respective apertures 130 therethrough adapted to receive pins 136 to couple the wearable device 500 to one or more carrier structures. The wearable device 500 may include one or both of charging ports 122 and/or charging coil 404.

The wearable device 500 may differ from the wearable device 100 and wearable device 300 in that the light emitter 120 and actuator 118 are separate devices. The light emitter 120 of the wearable device 500 may be like that of the wearable device 100 in that the light emitter 120 can emit any color of light.

The wearable device 500 includes the tangs 402 discussed with respect to the wearable device 400.

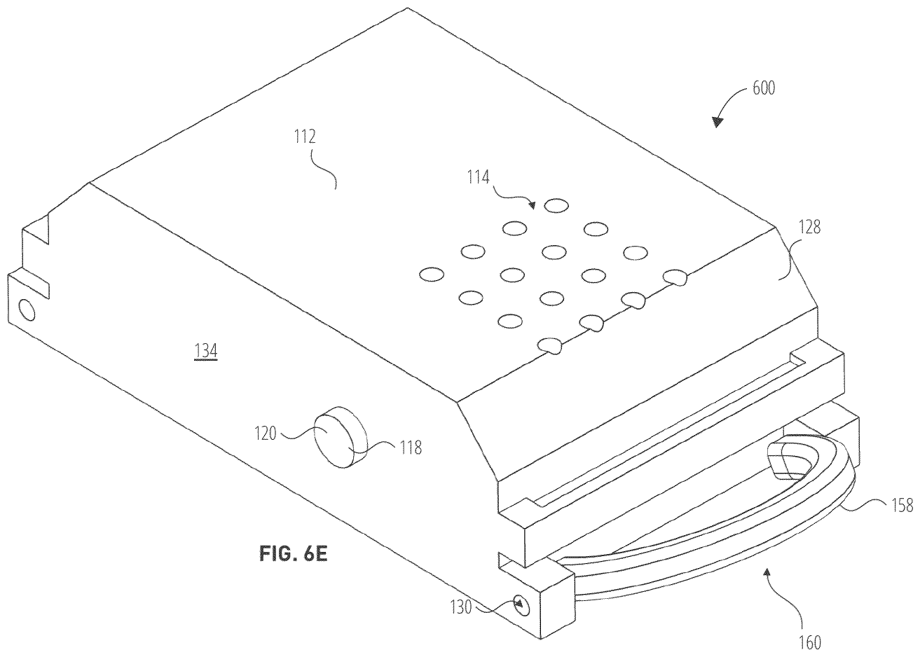

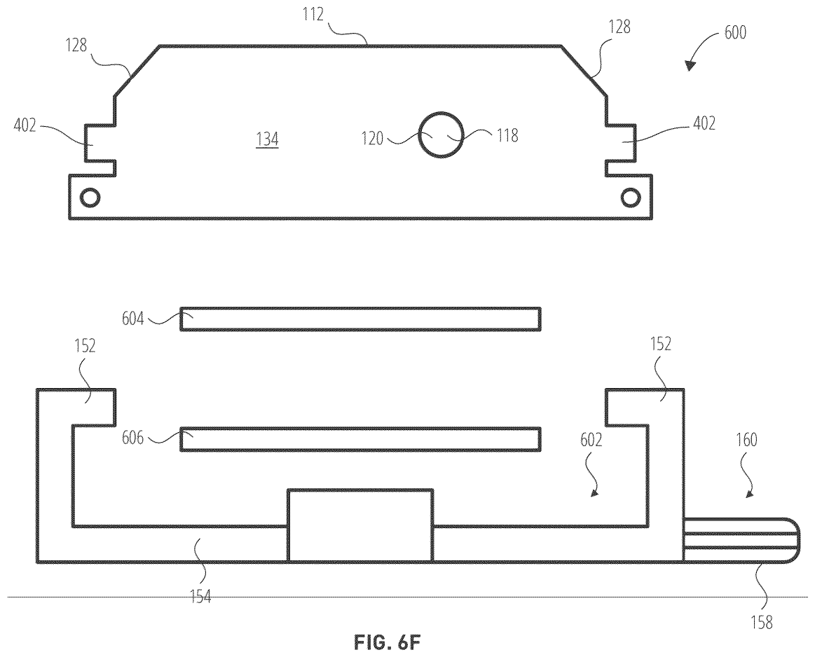

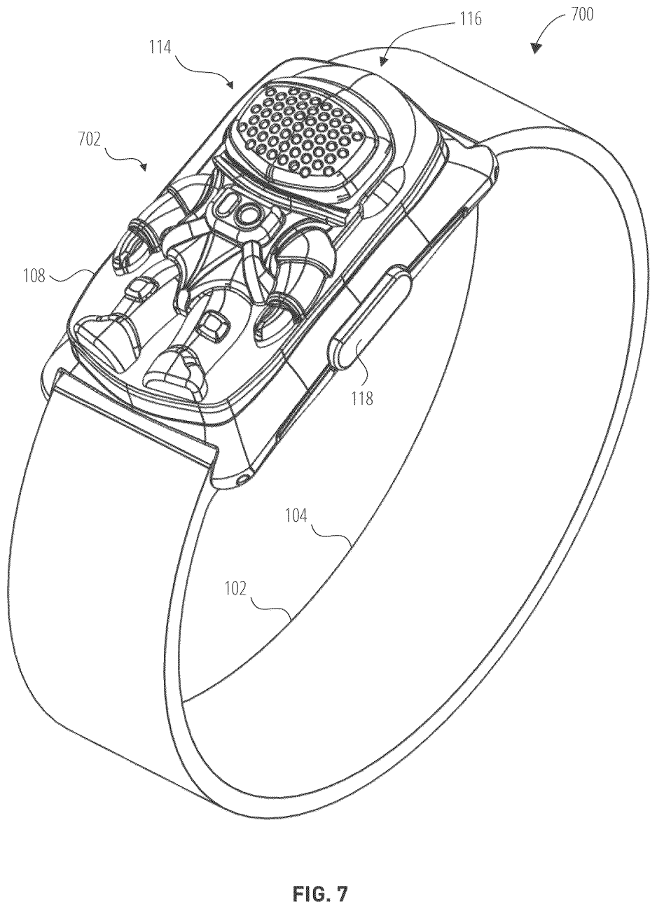

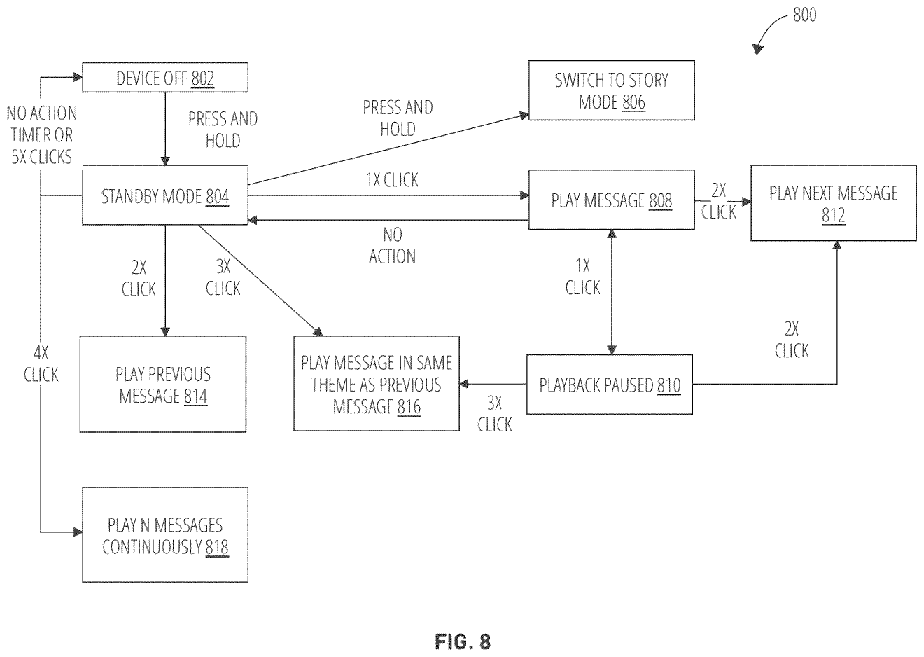

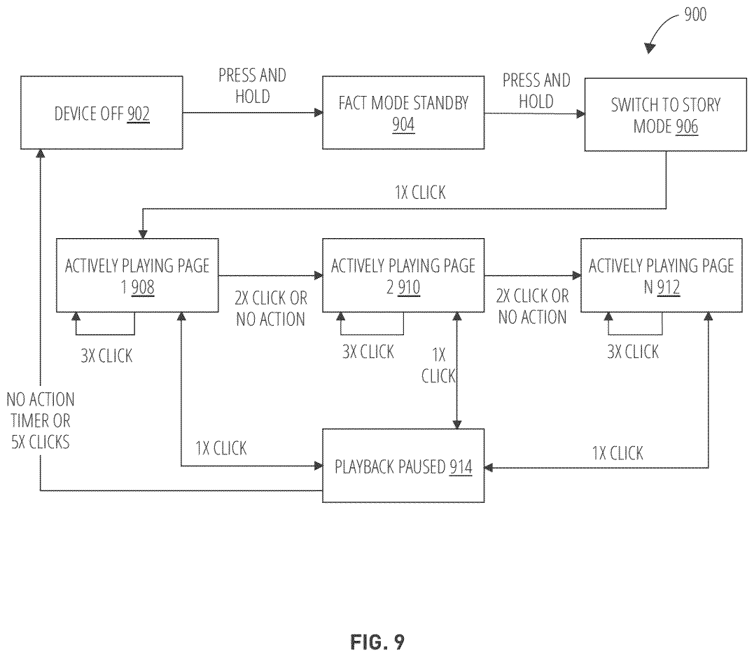

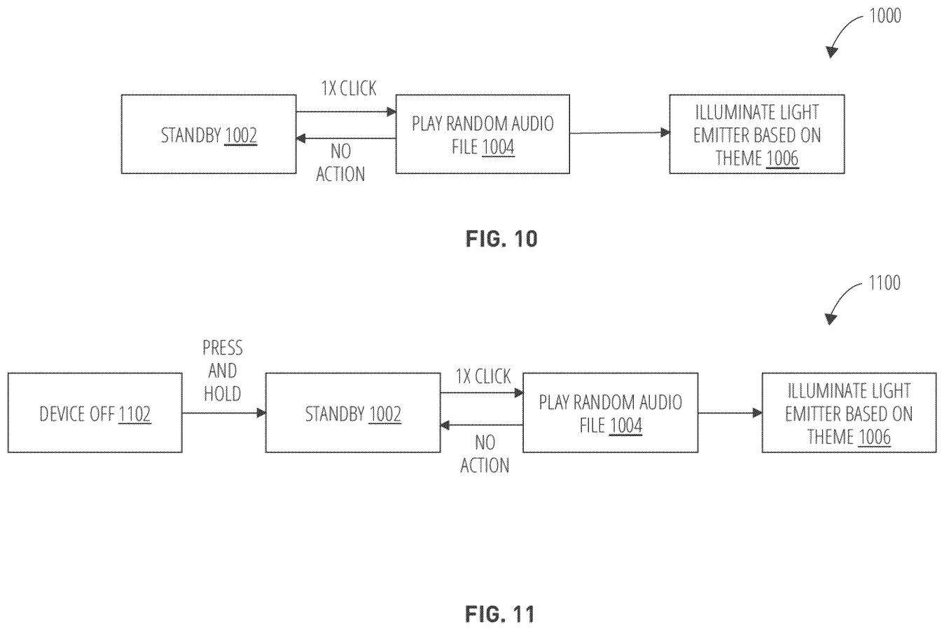

Turning to FIG. 6A-FIG. 6F, a wearable device 600 is shown. The wearable device 600 is similar to the other wearable devices disclosed herein, such as the wearable device 100, 200, 300, 400, and/or 500 in many aspects. For example, the wearable device 600 includes a main body 108 with a rear panel 110, and a front panel 112, joined by an edge panel 134, an end portion 124, an end portion 126 and optionally, a transition portion 128. The wearable device 600 includes a grille 114 that protects an audio transducer 116. An actuator 118 is disposed on a panel of the main body 108, such as the edge panel 134. The end portions 124/126 include flanges 138 that form a receiver 140. The flanges 138 include respective apertures 130 therethrough adapted to receive pins 136 to couple the wearable device 600 to one or more carrier structures. The wearable device 600 may include one or both of a charging port 122 and/or charging coil 404. The wearable device 600 includes the tangs 402 similar to the wearable device 400 and the wearable device 500. The wearable device 600 includes a combined actuator 118/light emitter 120 such as described with respect to the wearable device 100.

The wearable device 400, wearable device 500, and/or wearable device 600 are all coupleable to a carrier structure 602. The carrier structure 602 includes a base 154 from which one or more flanges 152 protrude. The flanges 152 are disposed at opposing ends of the base 154. The flanges 152 form a receptacle 150 therebetween. The receptacle 150 is adapted to receive the wearable device 400/500/600. As shown for example in FIG. 6B and FIG. 6C, the base 154 and/or flanges 152 of the carrier structure 602 may be temporarily (e.g., resiliently or elastically) bent such that the flanges 152 snap into the tangs 402 of the wearable device 400/500/600. Thus the respective wearable devices may be coupled, including selectively coupled, to the carrier structure 602 without tools or pins.

The carrier structure 602 may include a hoop 158 at one or both ends (e.g., adjacent to the flanges 152). The hoop 158 forms an opening 160 that may facilitate attachment of the carrier structure 148 to another device, such as a neckless, ring, key ring, etc.

As shown for example in FIG. 6D, the wearable device 600 may include apertures 130 formed in the flanges 152 as described with respect to the wearable device 100, such that the wearable device 600 may be selectively coupled t a carrier structure 102 such as a strap. Similarly, the wearable device 400 and/or wearable device 500 may be coupleable to a carrier structure 102.

As shown for example in FIG. 6E, the apertures 130 of the wearable device 600 may receive pins that couple one or both end portions 124/126 to a hoop 158 that forms an opening 160 suitable for coupling the wearable device 600 to another device (e.g., neckless, bracelet, or the like). In the embodiment shown in FIG. 6E, the hoop 158 pivots about the apertures 130. In some embodiments, the pins 136 are formed with the hoop 158. In some embodiments, the pins 136 are separate devices. The wearable device 100, wearable device 200, wearable device 400, and/or wearable device 500 may be similarly coupleable to a pivoting hoop 158.

As shown for example in FIG. 6F, the wearable device 600 may be additionally or alternately coupleable to the carrier structure 602 or another carrier structure via one or more magnetic elements 604/606 that may be attracted to one another. For example, the magnetic element 604 and/or magnetic element 606 may be a ferrous material, rare earth magnet, or the like.

Turning to FIG. 7, a wearable device 700 is shown. The wearable device 700 is similar to the other wearable devices disclosed herein, such as the wearable device 100, 200, 300, 400, 500 and/or 600 in many aspects. For example, the wearable device 700 includes a main body 108 with a rear panel 110, and a front panel 112, joined by an edge panel 134, an end portion 124, an end portion 126 and optionally, a transition portion 128. The wearable device 700 includes a grille 114 that protects an audio transducer 116. An actuator 118 is disposed on a panel of the main body 108, such as the edge panel 134. The end portions 124/126 include flanges 138 that form a receiver 140. The flanges 138 include respective apertures 130 therethrough adapted to receive pins 136 to couple the wearable device 500 to one or more carrier structures. The wearable device 700 may include one or both of a charging port 122 and/or charging coil 404. The wearable device 600 includes a combined actuator 118/light emitter 120 such as described with respect to the wearable device 100.

The wearable device 700 includes a thematic element 132 in the form of a character 702. For example, the character 702 may represent a real person (e.g., an astronaut, a religious or inspirational figure) or a fictional character (e.g., a storybook character). As shown for example in FIG. 7, the character 702 may be formed with a panel, e.g., a front panel 112 of the wearable device 700.

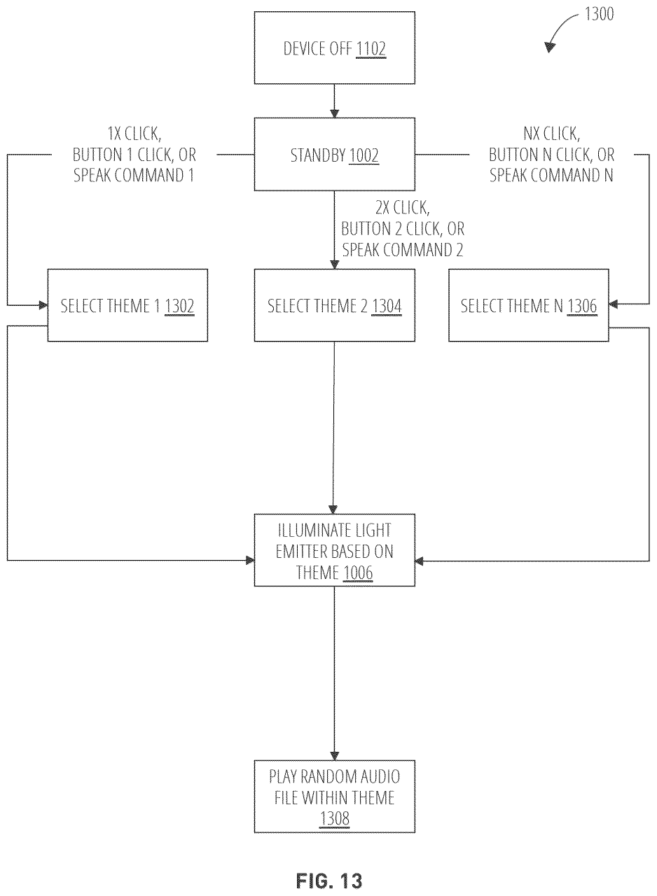

FIG. 8-FIG. 17 show example systems and methods of using wearable devices disclosed herein. Any wearable device herein may operate in a variety of modes. In some examples, a wearable device operates in a fact mode where the wearable device plays messages categorized into one or more themes. In some embodiments, the wearable devices play a story, divided into virtual (or representing actual) book pages, story mode. Table 1-Table 4 show examples of user interface indications and associated actions for embodiments of wearable devices disclosed herein. Table 1 shows an example of user interface states (e.g., blinking pattern of the light emitter 120/202) and the associated action of the wearable device for a wearable device in fact mode.

TABLE 1
example wearable device light emitter states
and associated actions - fact mode

| | |
|---|---|
| fast blinking red | Low battery |
| multi-color flash | Device powered on or mode changed |
| slow pulse white | Device off or in standby |
| green pulsing | Actively charging |
| solid red | Theme of selected fact categorized as |
| | astronaut and space travel facts |
| solid blue | Theme of selected fact categorized as |
| | earth facts |
| solid green | Theme of selected fact categorized as |
| | time and distance in space facts or |
| | charging complete |
| solid white | Theme of selected fact categorized as |
| | moon and asteroid facts |
| solid purple | Theme of selected fact categorized as |
| | solar system facts |
| solid yellow | Theme of selected fact categorized as |
| | stars and galaxies facts |
| yellow flash | error/fault |

Table 2 shows an example of user interface states (e.g., blinking pattern of the light emitter 120/202) and the associated action of the wearable device for a wearable device in a fact mode where the themes represent emotions.

TABLE 2
example wearable device light emitter states
and associated actions - fact mode

| | |
|---|---|
| fast blinking red | Low battery |
| multi-color flash | Device powered on or mode changed |
| slow pulse white | Device off or in standby |
| green pulsing | Actively charging |
| solid red | Theme of selected fact categorized as |
| | forgiveness |
| solid blue | Theme of selected fact categorized as |
| | contentment |
| solid green | Theme of selected fact categorized as |
| | joy or charging complete |
| solid white | Theme of selected fact categorized as |
| | empowerment |
| solid purple | Theme of selected fact categorized as |
| | reverence |
| solid yellow | Theme of selected fact categorized as |
| | calm |
| yellow flash | error/fault |

Table 3 is a table of example actuator 118 actions and functions correlated thereto for a fact mode of any wearable device disclosed herein. See also FIG. 8 and related description.

TABLE 3
example actuator 118 actions and related functions - fact mode

| | |
|---|---|
| press and hold | toggle power on/off |
| press and hold | toggle story mode and fact mode |
| while on or in | |
| standby | |
| 1x click | play single random message if in standby |
| 1x click | pause playing if actively playing audio |
| 1x click | continue playing if paused |
| 2x click | start playing new message if paused or actively playing |
| 2x click | replay last message if in standby |
| 3x click | play single random message in the same category as the |
| | last played message |
| 4x click | play random number (e.g., 30) messages |
| 5x click | power device off |

Table 4 shows example actuator 118 actions and associated functions correlated thereto for a story mode of any wearable device disclosed herein. See also FIG. 9 and related description.

TABLE 4
example actuator 118 actions and related functions

| | |
|---|---|
| press and hold | toggle between fact mode and story mode |
| 1x click | begin story, if in standby |
| 1x click | pause story if actively playing |
| 1x click | continue story |
| 2x click | start next page if actively playing or paused |
| 3x click | restart current page |
| 5x click | power device off |

FIG. 8 illustrates an example method 800 for operating a wearable device in fact mode. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

In any method disclosed herein, sample actions and inputs from the actuator 118 that cause the wearable device to move from one operation to another are by example only and not limiting. For example if an action of 1× click on the actuator 118 causes a method to move between two states, in other examples, that same movement may be caused by any number or combination of clicks, pauses, holds and combinations of the same or by the use of two or more actuators.

According to some examples, the method 800 includes turning the wearable device off at operation 802. In many cases, the method 800 may begin in the operation 802. If, in the operation 802, the user presses and holds the actuator 118 (e.g., for a second) the method 800 may move to the operation 804. For example, from standby mode in operation 804, if no action is taken for a predetermined time, or the user presses the actuator 118 five times (5×) the method 800 may proceed to operation 802 and the wearable device turns off.

According to some examples, the method 800 includes entering standby mode at operation 804. In standby mode the wearable device may be ready to receive further user input from the actuator 118 but may be in a low power mode (e.g., lights and sounds off). As shown for example in Table 3 from operation 804, the method 800 may proceed to any one of operation 802, operation 806, operation 808, operation 814, operation 816, and/or operation 818.

According to some examples, the method 800 includes switching to story mode at operation 806. See FIG. 9 and related description.

According to some examples, the method 800 includes actively playing a message at operation 808. The message may be selected by the processing element 1802 from memory component 1808 according to a pattern, or at random. In some embodiments, a theme may be selected, e.g., at random, and a message categorized with that selected theme is selected. After selecting the message, the method 800 causes the wearable device to play the selected message via the audio transducer 116. If during the operation 808 the user presses the actuator 118 one time, the method 800 may pass to the operation 810 and the playback is paused. If during the operation 808 the user presses the actuator 118 two times (2×), the method 800 may proceed to operation 812 and the wearable device selects a new message for playback. If playback proceeds to the completion of the message, the method 800 may return to operation 804, standby.

According to some examples, the method 800 includes pausing playback at operation 810. In the operation 810 the wearable device stops playing the currently playing message. If, during the operation 810, the user presses the actuator 118 one time, the method 800 may return to operation 808 and continue playing the selected message. If, during the operation 810, the user presses the actuator 118 two times, the method 800 may proceed to the operation 812 and the wearable device selects a new message to play. If, during the operation 810, the user presses the actuator 118 three times (3×) the method 800 may proceed to the operation 816.

According to some examples, the method 800 includes actively playing the next message at operation 812. The operation 812 is substantially similar to the operation 808 but is usually called during active playback or pause of a message.

According to some examples, the method 800 includes actively playing a previously played message at operation 814. For example, the memory component 1808 may store a record of the messages played and the method 800 may recall and play one or more previously played messages. For example if the user clicks the actuator 118 twice (2×) from standby mode, the method 800 may replay the last-played message again.

According to some examples, the method 800 includes playing a new message having the same theme as the previously played message. For example, if the wearable device is in standby mode in operation 808 and the user presses the actuator 118 two times (2×), the method 800 may proceed to the operation 818. For example, if the last-played message in operation 808 or operation 812 was facts about the moon, in operation 816 the wearable device may play a new fact about the moon.

According to some examples, the method 800 includes actively playing a number N messages continuously at operation 818. For example, the method 800 may cause the wearable device to play 2, 5, 10, 30, or more messages in succession. For example, if the wearable device is in standby mode in operation 808 and the user presses the actuator 118 four times (4×), the method 800 may proceed to the operation 818.

FIG. 9 illustrates an example method 900 for operating any wearable device herein in story mode. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

In story mode, a wearable device reads a story aloud. The story may be broken in to one or more discrete portions called pages that may represent real pages in a physical book, virtual pages in an electronic book, or some other portion of the story.

According to some examples, the method 900 begins with the device off in operation 902.

According to some examples, the method 900 may move to operation 904 from the operation 902 if the actuator 118 is pressed and held (e.g., for a second). In standby mode, the wearable device may be ready to receive further input from the user 1602 via the actuator 118 but may be in a low power state (e.g., not illuminating the light emitter 120 or playing any sound). If, in operation 904, the actuator 118 is pressed and held again, the wearable device may switch to story mode in operation 906 (see, e.g., FIG. 8 and related discussion).

According to some examples, the method 900 includes actively playing page 1 of a story at operation 908. In some embodiments, the method 900 may return to operation 908 and repeat the first page (e.g., if the user 1602 presses the actuator 118 3×). If, during the operation 908, the user presses the actuator 118 twice (2×), the method 900 may proceed to the operation 910 and the wearable device begins playing page 2 of the story. The method 900 may also proceed to operation 910 if the user takes no action and the wearable device plays all of the first page.

According to some examples, the method 900 includes actively playing page 2 at operation 910. The operation 910 is substantially the same as the operation 908 but for the second page in the story.

According to some examples, the method 900 includes actively playing page N at operation 912. Similarly, operation 912 is substantially the same as operation 908 and operation 910 but for the Nth page in the story. The method 900 may proceed from operation 912 to operation 912 repeatedly until all the pages of a story are played.

According to some examples, the method 900 pauses playback at operation 914. For example, if the user 1602 presses the actuator 118 one time during playback of a page, the wearable device may pause or resume playback of a given page.

FIG. 10 illustrates an example method 1000 for operating a wearable device disclosed herein. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

According to some examples, the method 1000 includes placing the wearable device in standby at operation 1002. Standby mode is as described elsewhere in this disclosure. From operation 1002, the method 1000 may proceed to operation 1004 if the user 1602 presses the actuator 118 one time, in some examples.

According to some examples, the method 1000 includes playing a random audio file at operation 1004. For example, the processing element 1802 may select a random file stored in memory component 1808 and cause the audio transducer 116 to play the audio. If the user 1602 takes no action in the operation 1004, the method 1000 returns to the operation 1002.

Before, during, and/or after the operation 1004, the method 1000 may proceed to the operation 1006 and illuminate the light emitter 120/202 with a color associated with the theme of the audio file played in the operation 1004.

In the method 1000, the wearable device is never off, but is ready to receive user commands via the actuator 118. The method 1000 has an advantage of responsiveness over power consumption.

FIG. 11 illustrates an example method 1100 for operating a wearable device disclosed herein. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

According to some examples, the method 1100 includes operation 1002, operation 1004, and operation 1006 as described with respect to the method 1000. The method 1100 includes an operation 1102 where the wearable device is powered off. The method 1100 may proceed to the operation 1002 for example, by the user 1602 pressing and holding the actuator 118 for a predetermined time.

In the method 1100, the device may be placed in an off mode to conserve power. The method 1100 prioritizes power saving over responsiveness.

FIG. 12 illustrates an example method 1200 for operating a wearable device disclosed herein. Although the example method 1200 depicts a particular sequence of operations, the sequence may be altered without departing from the scope of the present disclosure. For example, some of the operations depicted may be performed in parallel or in a different sequence that does not materially affect the function of the method 1200. In other examples, different components of an example device or system that implements the method 1200 may perform functions at substantially the same time or in a specific sequence.

According to some examples, the method 1200 is substantially similar to the method 1000, except the operation 1002 where the wearable device is in standby is replaced by the operation 1102 and the device defaults to off.

The method 1200 beneficially provides additional power savings compared to the method 1100.

FIG. 13 illustrates an example method 1300 for operating a wearable device disclosed herein in a theme selection mode. Although the example method 1300 depicts a particular sequence of operations, the sequence may be altered without departing from the scope of the present disclosure. For example, some of the operations depicted may be performed in parallel or in a different sequence that does not materially affect the function of the method 1300. In other examples, different components of an example device or system that implements the method 1300 may perform functions at substantially the same time or in a specific sequence.

According to some examples, the method 1300 includes standby at operation 1002 as described with respect to the method 1000.

According to some examples, the method 1300 includes illuminating the light emitter based on a theme of a selected message at operation 1006, as described with respect to the method 1000.

According to some examples, the method 1300 includes powering the wearable device off at operation 1102, as described with respect to the method 1100.

According to some examples, the method 1300 includes selecting theme 1 at operation 1302. For example, the user 1602 may click the actuator 118 one time (in examples where the wearable device includes one actuator), click a first actuator (in cases where the wearable device includes more than one actuator), or may receive a speech command to select a theme. Similarly, the method 1300 includes selecting a second theme, (e.g., by clicking the actuator 118 twice, clicking the second actuator if present, or receiving a second voice command) in operation 1304. The operation 1306 is similar to the operation 1302 and 1304 for the Nth theme. From any of the operation 1302, the operation 1304, or the operation 1306, the method 1300 may proceed to the operation 1006 and the wearable device illuminates the light emitter 120/202 based on the selected theme, as describes with respect to the operation 1006.

According to some examples, the method 1300 includes a playing random audio file within theme at operation 1308. For example, the wearable device may select a random message having the selected theme for playback via the audio transducer 116.

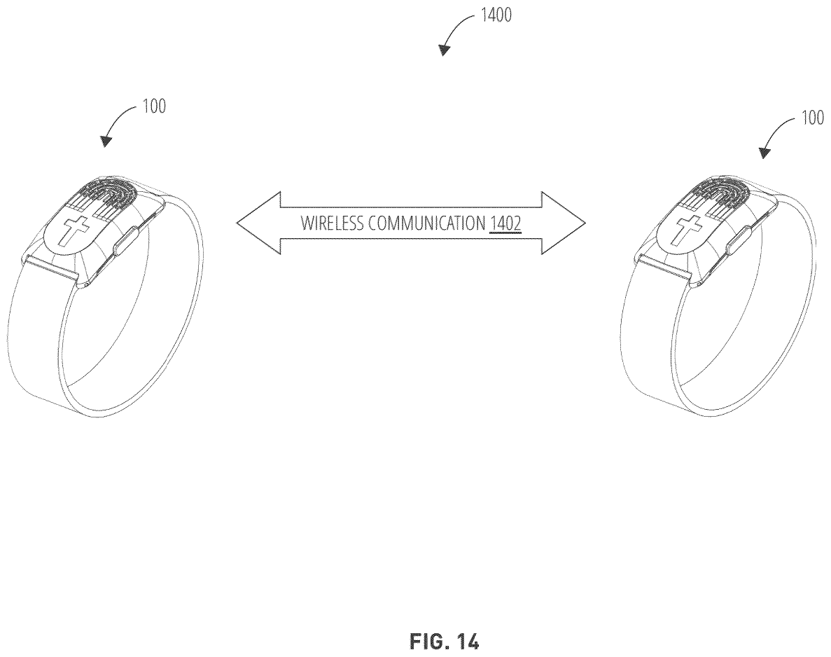

FIG. 14 shows an example system 1400 including two or more wearable devices in wireless communication with one another. Although the wearable device 100 is shown in FIG. 14, the system 1400 is applicable to any wearable device disclosed herein. In various examples, the wireless communication 1402 includes one or more of Wi-Fi, Bluetooth, cellular networks, satellite communication, infrared communication, radio broadcasting, Zigbee, z-wave, or near field communication.

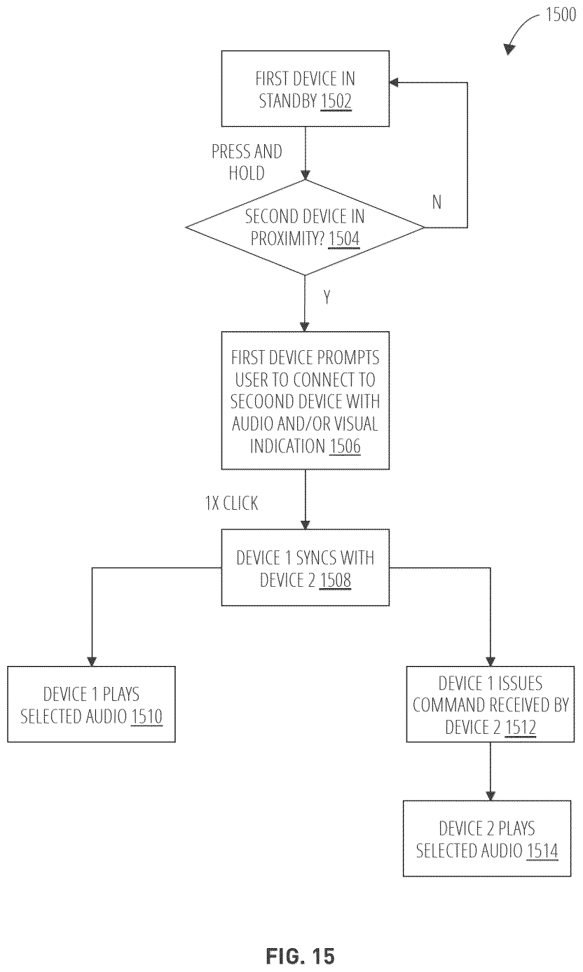

FIG. 15 illustrates an example method 1500 for operating the system 1400. Although the example method 1500 depicts a particular sequence of operations, the sequence may be altered without departing from the scope of the present disclosure. For example, some of the operations depicted may be performed in parallel or in a different sequence that does not materially affect the function of the method 1500. In other examples, different components of an example device or system that implements the method 1500 may perform functions at substantially the same time or in a specific sequence.

According to some examples, the method 1500 includes placing one or more wearable devices in standby at operation 1502, as described with respect to operation 1002. The method 1500 may proceed to the operation 1504 for example, if the user 1602 presses and holds the actuator 118 for a predetermined time.

According to some examples, the method 1500 includes sensing if a second wearable device is in proximity to the first wearable device. For example, the first wearable device may receive a wireless signal from the second wearable device. If no second device is discovered, the method 1500 may return to the operation 1502. If a second device is in proximity, the method 1500 may proceed to the operation 1506.

According to some examples, the method 1500 includes prompting the user to connect to the second wearable device with an audio or visual indicator at operation 1506. For example, the light emitter 120 may illuminate, flash, etc. and/or the audio transducer 116 may play a message, chime, or tone indicating the availability of a connection.

According to some examples, the method 1500 includes synchronizing the first wearable device and the second wearable device with one another at operation 1508. For example, the wearable devices in the system 1400 may communicate with one another to establish a wireless communications 1402 link with one or more synchronization messages.

According to some examples, the method 1500 includes causing the first wearable device to plays the selected message or a message with the selected theme at operation 1510.

According to some examples, the method 1500 causes the first wearable device to issue a command received by the second wearable device at operation 1512. For example, the first wearable device may select a message or theme to play and send a command to the second audio device to play the same message or theme.

According to some examples, the method 1500 causes the second wearable device to play the selected message at operation 1514.

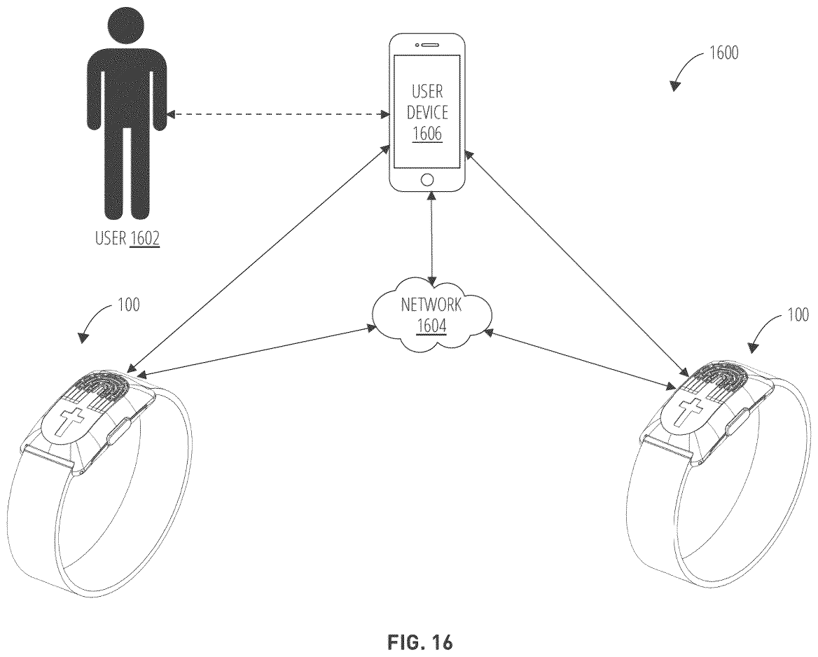

The system 1600 is a schematic of a system 1600 for communication between two or more wearable devices and a user device 1606. Although the wearable device 100 is shown in FIG. 16, the system 1400 is applicable to any wearable device disclosed herein. Any of the devices of the system 1600 may be in wireless communication 1402 or wired communication such a via a cable by ethernet, USB, or the like. The wearable devices 100 may be in communication with one another or the user device 1606 directly or via a network 1604.

In many embodiments, the user device 1606 is a smart phone, tablet, watch, laptop, desktop, or server.

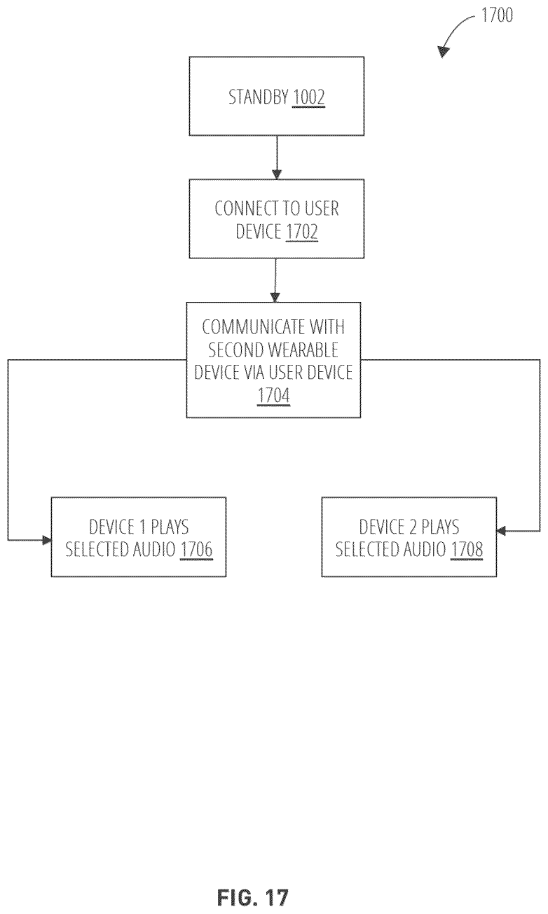

FIG. 17 illustrates an example method 1700 for operating the system 1600. Although the example method 1700 depicts a particular sequence of operations, the sequence may be altered without departing from the scope of the present disclosure. For example, some of the operations depicted may be performed in parallel or in a different sequence that does not materially affect the function of the method 1700. In other examples, different components of an example device or system that implements the method 1700 may perform functions at substantially the same time or in a specific sequence.

According to some examples, the method 1700 includes placing the wearable devices in standby at operation 11002 as described with respect to the method 1000.

According to some examples, the method 1700 includes connecting one or more wearable device to the user device 1606 at operation 1702. Such connection may be made by wired or wireless communication 1402.

According to some examples, the method 1700 includes communicating with a second wearable device via user device 1606 at operation 1704. Such communication may be made by wired or wireless communication 1402. For example, an application executed by the user device 1606 may enable the sharing or synchronizing of one or more selected messages or themes between and among connected wearable devices.

According to some examples, the method 1700 includes causing the first wearable device to play selected audio at operation 1706.

According to some examples, the method 1700 includes causing the second wearable device to play selected audio at operation 1708. The operation 1706 and operation 1708 may happen sequentially, may overlap, or may happen at the same time.

FIG. 18 is a simplified block diagram of components of a user device 1606 and/or a wearable device disclosed herein, such as the wearable device 100, the wearable device 200, the wearable device 300, the wearable device 400, the wearable device 500, the wearable device 600, and/or the wearable device 700. For example, the processing element 1802 and the memory component 1808 may be located at one or in several wearable devices. This disclosure contemplates any suitable number of such wearable devices. In some examples, the processing element 1802 is located in a device other than the wearable device such as for example, a server, a desktop computing system, a mainframe, a blade, a mesh of wearable devices, a laptop or notebook wearable device, a tablet wearable device, an embedded wearable device, a system-on-chip, a single-board wearable device, or a combination of two or more of these. Where appropriate, a wearable device may include one or more processing element 1802; be unitary or distributed; span multiple locations; span multiple machines; span multiple data centers; or reside in a cloud, which may include one or more cloud components in one or more networks. A wearable device may include one or more processing elements 1802, an input/output I/O interface 1804, one or more external devices 1812, one or more memory components 608, and a network interface 1810. Each of the various components may be in communication with one another through one or more buses or communication networks, such as wired or wireless networks, e.g., the network 1604. The components in FIG. 18 are exemplary only. In various examples, the wearable device may include additional components and/or functionality not shown in FIG. 18.

The processing element 1802 may be any type of electronic device capable of processing, receiving, and/or transmitting instructions. For example, the processing element 1802 may be a central processing unit, microprocessor, processor, or microcontroller. Additionally, it should be noted that some components of the wearable device may be controlled by a first processing element 1802 and other components may be controlled by a second processing element 1802, where the first and second processing elements may or may not be in communication with each other.

The I/O interface 1804 allows a user to enter data into wearable device, as well as provides an input/output for the wearable device to communicate with other devices or services. The I/O interface 1804 can include one or more input buttons (e.g., an actuator 118), touch pads, touch screens, and so on.

The external device 1812 are one or more devices that can be used to provide various inputs to the wearable devices, e.g., mouse, microphone, keyboard, trackpad, etc. The external devices 1812 may be local or remote and may vary as desired. In some examples, the external devices 1812 may also include one or more additional sensors.

The memory components 1808 are used by the wearable device to store instructions and/or data for the processing element 1802 such as the messages, audio files, user interface routines, user preferences, alerts, etc. The memory components 1808 may be, for example, magneto-optical storage, read-only memory, random access memory, erasable programmable memory, flash memory, or a combination of one or more types of memory components.

The network interface 1810 provides communication to and from the wearable device to other devices such as other wearable devices, user devices 1606, the network 1604, etc. The network interface 1810 includes one or more communication protocols, such as, but not limited to Wi-Fi, Ethernet, Bluetooth, etc. The network interface 1810 may also include one or more hardwired components, such as a Universal Serial Bus (USB) cable, or the like. The configuration of the network interface 1810 depends on the types of communication desired and may be modified to communicate via Wi-Fi, Bluetooth, etc.

The light emitter 1806 provides a visual output for the wearable device and may be varied as needed based on the device. The light emitter 1806 may be configured to provide visual feedback to the user 1602 and may include one or more light emitting diodes (LEDs) (e.g., a color-addressable LED), liquid crystal display screen, light emitting diode screen, plasma screen, light pipe, or the like. In some examples, the light emitter 1806 may be configured to act as an input element (such as the actuator 118) for the user 1602 through touch feedback or the like.

The wearable devices include a power source 1814. In many embodiments, the power source 1814 is a secondary (rechargeable) battery. In some embodiments, the power source 1814 may be a primary (single use) battery. The battery may include one or more of a nickel metal hydride battery, lithium battery, nickel cadmium battery, alkaline battery, or the like. In embodiments where the power source 1814 is rechargeable, the power source 1814 may be chargeable by a charging port 122 and/or charging coil 404.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular.

Unless the context clearly requires otherwise, throughout the description and the claims, the words ‘comprise,’ ‘comprising,’ and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A wearable device comprising:
a processor in electrical communication with:
a non-transitory computer-readable storage medium storing a plurality of messages,
an actuator,
an audio transducer, and
a light emitter, wherein, responsive to the actuator receiving a user input, the processor:
retrieves a message of the plurality of messages from the storage medium,
illuminates the light emitter with a color corresponding to a theme associated with the retrieved message, and
plays the message via the audio transducer.

2. The wearable device of claim 1, wherein responsive to the actuator receiving the user input, the processor:
retrieves a message of the plurality of messages from the storage medium,
subsequent to retrieving the message, illuminates the light emitter with a color corresponding to a theme associated with the retrieved message, and
subsequent to illuminating the light emitter, plays the message via the audio transducer.

3. The wearable device of claim 1, wherein responsive to the actuator receiving the user input, the processor:
selects a theme from the plurality of themes;
retrieves a message of the plurality of messages from the storage medium based on the theme,
subsequent to retrieving the message, illuminates the light emitter with a color corresponding to a theme associated with the retrieved message, and
subsequent to illuminating the light emitter, plays the message via the audio transducer.

4. The wearable device of claim 1, wherein at least one theme of the plurality of themes describes an emotion.

5. The wearable device of claim 4, wherein at least one theme of the plurality of themes describes a fact type.

6. The wearable device of claim 4, wherein the emotion comprises one or more of joy, forgiveness, contentment, reverence, calm or empowerment.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The wearable device of claim 1, wherein the light emitter illuminates the actuator.

22. The wearable device of claim 1, wherein the plurality of messages comprises excerpts from a scripture.

23. The wearable device of claim 1, wherein the device comprises a modular wearable device connectable to a plurality of carrier structures.

24. (canceled)

25. The wearable device of claim 22, wherein the scripture comprises one or more of The New Testament, The Old Testament, The Quran, The Tanakh, The Torah, The Nevi'im, The Ketuvim, The Vedas, The Upanishads, The Bhagavad Gita, The Ramayana, The Mahabharata, The Tripitaka, The Mahayana Sutras, The Tibetan Book of the Dead, The Guru Granth Sahib, The Book of Mormon, The Doctrine and Covenants, The Pearl of Great Price, The Kitab-i-Aqdas, The Writings of Baha'u'llah, The Avesta, The Yasna, The Visperad, or The Vendidad.

26. A non-transitory computer-readable storage medium, the computer-readable storage medium including instructions that when executed by a computer, cause the computer to:
retrieve a message of a plurality of messages stored in the storage medium, wherein each message is categorized into at least one of a plurality of themes;
illuminate a light emitter with a color corresponding to a theme associated with the retrieved message, and
plays the message via an audio transducer.

27. The non-transitory computer-readable storage medium of claim 26, wherein at least one theme of the plurality of themes describes an emotion.

28. The non-transitory computer-readable storage medium of claim 27, wherein at least one theme of the plurality of themes describes a fact type.

29. The non-transitory computer-readable storage medium of claim 27, wherein the emotion comprises one or more of joy, forgiveness, contentment, reverence, calm or empowerment.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. The non-transitory computer-readable storage medium of claim 26, wherein the light emitter illuminates the actuator.

45. The non-transitory computer-readable storage medium of claim 26, wherein the plurality of messages comprise excerpts from a scripture.

46. The non-transitory computer-readable storage medium of claim 26, wherein the device comprises a modular wearable device connectable to a plurality of carrier structures.

47. (canceled)

48. The non-transitory computer-readable storage medium of claim 45, wherein the scripture comprises one or more of The New Testament, The Old Testament, The Quran, The Tanakh, The Torah, The Nevi'im, The Ketuvim, The Vedas, The Upanishads, The Bhagavad Gita, The Ramayana, The Mahabharata, The Tripitaka, The Mahayana Sutras, The Tibetan Book of the Dead, The Guru Granth Sahib, The Book of Mormon, The Doctrine and Covenants, The Pearl of Great Price, The Kitab-i-Aqdas, The Writings of Baha'u'llah, The Avesta, The Yasna, The Visperad, or The Vendidad.

49. A system comprising:
a first wearable device; and
a second wearable device, wherein:
the first wearable device and the second wearable device are in wireless communication with one another,
each of the first wearable device and the second wearable device comprises:
a processor in electrical communication with a non-transitory computer-readable storage medium storing a plurality of messages, each message being categorized into at least one of a plurality of themes, and
one of the first wearable device or the second wearable device is configured to transit a message of the plurality of messages to the other of the second wearable device or the first wearable device via the wireless communication.

50. The system of claim 49, wherein each of the first wearable device and the second wearable device comprises:
an actuator;
an audio transducer; and
a light emitter, wherein responsive to the actuator receiving a user input, the processor or the respective user device receiving the user input plays the transmitted message via the audio transducer, and illuminates the light emitter with a color corresponding to a theme associated with the transmitted message.
